(19) United States
(12) Patent Application Publication
(10) Pub. No.: US 2026/0257325 A1
(43) Pub. Date: Sep. 3, 2026

(54) TOOL SYSTEM, WORK TARGET IDENTIFICATION METHOD, AND PROGRAM

(71) Applicant: Panasonic Intellectual Property Management Co., Ltd., Osaka (JP)

(72) Inventors: Tomoka KATAYAMA, Osaka (JP); Kazuo DOBASHI, Osaka (JP); Mutsuhiro YAMANAKA, Osaka (JP); Kosuke TARU, Osaka (JP); Koji UEKUSA, Chiba (JP)

(21) Appl. No.: 18/881,620

(22) PCT Filed: Jul. 6, 2023
(86) PCT No.: PCT/JP2023/025174

§ 371 Date: Jan. 6, 2025

(30) Foreign Application Priority Data
Aug. 10, 2022 (JP) 2022-128299

(51) Int. Cl. B25B 23/147; B25B 23/18; B25F 5/02; G06V 10/10; G06V 10/74; G06V 20/50

(52) U.S. Cl. CPC B25B 23/1475; G06V 10/17; G06V 10/74; G06V 20/50; B25B 23/18; B25F 5/02

(57) ABSTRACT

A tool system includes a portable tool, an image capturing unit, a processor, and a start of operations detector. The image capturing unit is provided for the tool and generates a captured image of a work target for the tool. The processor performs identification processing including performing image processing on the captured image generated by the image capturing unit and thereby determining whether the work target matches any of one or more preregistered targets. The start of operations detector detects a start of operations on the work target in a state where the work target is identified to be any of the one or more targets as a result of the identification processing. The processor suspends, once the start of operations detector has detected the start of operations, the image processing on the captured image in the identification processing.

### TECHNICAL FIELD

The present disclosure generally relates to a tool system, a work target identification method, and a program, and more particularly relates to a tool system including a portable tool, a work target identification method, and a program.

### BACKGROUND ART

Patent Literature 1 discloses a tool system including a portable tool. The tool includes an image capturing unit arranged to capture an image of a work target during operations and an identification unit. The identification unit performs, on a captured image generated by the image capturing unit, pattern matching processing using, as template data, a plurality of reference images respectively corresponding to the plurality of work targets, thereby identifying a current work target, on which the tool is currently set in place, to be any one of the plurality of work targets. The tool is configured, if the current work target identified by the identification unit does not conform with the order of operations process steps defined by a reference procedure of operations, not to activate a driving unit even if the tool is subjected to a driving operation.

In general, the portable tool is driven by battery, and therefore, there has an increasing demand for cutting down its power consumption.

### CITATION LIST

### Patent Literature

Patent Literature 1: JP 2021-175593 A

### SUMMARY OF INVENTION

An object of the present disclosure is to provide a tool system, a work target identification method, and a program, all of which contribute to cutting down power consumption.

A tool system according to an aspect of the present disclosure includes a portable tool, an image capturing unit, a processor, and a start of operations detector. The tool includes a driving unit to be activated with motive power supplied from a power source. The image capturing unit is provided for the tool and generates a captured image of a work target for the tool. The processor performs identification processing including performing image processing on the captured image generated by the image capturing unit and thereby determining whether the work target matches any of one or more preregistered targets. The start of operations detector detects a start of operations on the work target in a state where the work target is identified to be any of the one or more targets as a result of the identification processing. The processor suspends, once the start of operations detector has detected the start of operations, the image processing on the captured image in the identification processing.

A work target identification method according to another aspect of the present disclosure includes an identification processing step and a start of operations detection step. The identification processing step includes performing image processing on a captured image generated by making an image capturing unit capture an image of a work target and thereby determining whether the work target matches any of one or more preregistered targets. The image capturing unit is installed in a portable tool. The tool includes a driving unit to be activated with motive power supplied from a power source. The start of operations detection step includes detecting a start of operations on the work target in a state where the work target is identified to be any of the one or more targets as a result of the identification processing step. The work target identification method includes suspending the image processing on the captured image in the identification processing step once the start of operations has been detected in the start of operations detection step.

A program according to still another aspect of the present disclosure is designed to cause a computer system to perform the work target identification method described above.

### BRIEF DESCRIPTION OF DRAWINGS

FIG. 1 is a block diagram of a tool system according to an exemplary embodiment;

FIG. 2 is a perspective view illustrating the appearance of the tool system as viewed from in front of the tool system;

FIG. 3 is a perspective view illustrating the appearance of the tool system as viewed from behind the tool system;

FIG. 4 is a sequence chart illustrating, as an example, how the tool system may work;

FIG. 5 is a flowchart illustrating, as an example, how the tool system may work;

FIG. 6 is a flowchart illustrating, as an example, how the tool system may work; and

FIG. 7 is a flowchart illustrating, as an example, how the tool system may work.

### DESCRIPTION OF EMBODIMENTS

A preferred embodiment of the present disclosure will now be described in detail with reference to the accompanying drawings. The drawings to be referred to in the following description of embodiments are all schematic representations. Thus, the ratio of the dimensions (including thicknesses) of respective constituent elements illustrated on the drawings does not always reflect their actual dimensional ratio. In the following description of embodiments, any pair of constituent elements, having the same function, will be designated by the same reference numeral and description of such elements will be omitted herein to avoid redundancy.

### EMBODIMENT

### (1) Overview

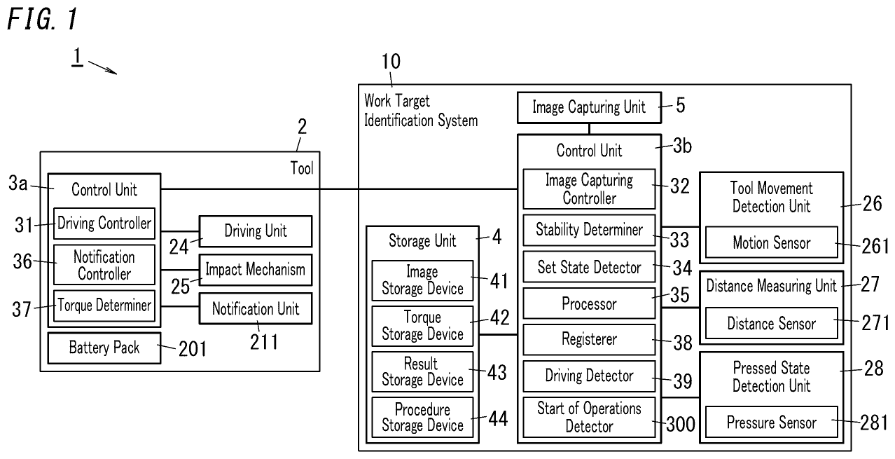

First, an overview of a tool system 1 according to an exemplary embodiment will be described with reference to FIG. 1.

A tool system 1 according to this embodiment includes a portable tool 2, an image capturing unit 5, a processor 35, and a start of operations detector 300.

The tool 2 includes a driving unit 24 to be activated with motive power supplied from a power source.

The image capturing unit 5 is provided for the tool 2 to generate a captured image of a work target for the tool 2.

The processor 35 performs identification processing. As used herein, the identification processing refers to processing including performing image processing on the captured image generated by the image capturing unit 5 and thereby determining whether the work target matches any of one or more preregistered targets.

The start of operations detector 300 detects a start of operations on the work target in a state where the work target is identified to be any of the one or more targets as a result of the identification processing.

The processor 35 suspends, once the start of operations detector 300 has detected the start of operations, the image processing on the captured image in the identification processing.

The tool 2 included in the tool system 1 includes a driving unit 24 including a motor, for example. The driving unit 24 is activated with motive power (such as electric power) supplied from a power source such as a battery pack 201. Examples of the tools 2 of this type include an impact wrench, a nut runner, an oil pulse wrench, a screwdriver (including an impact screwdriver), a drill or a drill-screwdriver, and various other types of tools.

Using a tool 2 of this type allows the user to perform various types of operations including assembling operations for manufacturing a product (such as a finished product or a semi-finished product) by assembling multiple components at a factory, for example, and construction operations including combining a plurality of buildup materials at a construction site, for example. Using the tool 2 allows the user to perform various types of operations such as attaching a fastening member (e.g., a bolt or a nut) onto a workpiece or drilling a hole through the workpiece. As used herein, the “target” refers to an object or a working area (part) on which operations are to be performed by using the tool 2. Examples of the “target” for the tool 2 include a workpiece to which a fastening member is to be attached and a workpiece to be subjected to machining such as drilling a hole. In the case of operations for fastening a fastening member, the target may include the fastening member to be attached to the workpiece. The tool 2 may be used in multiple types of operations. Thus, multiple types of targets for multiple types of operations involving the use of the tool 2 are preregistered with the tool system 1 according to this embodiment.

Also, as used herein, the “work target” for the tool 2 refers to a target which is arranged to be ready to be subjected to operations using the tool 2. For example, if the operations using the tool 2 are fastening operations including fastening a fastening member such as a bolt as a target onto a workpiece, then the work target for the tool 2 is a target (fastening member) arranged to be ready to be subjected to the fastening operations which belongs to a plurality of targets (fastening members). That is to say, a work target shot by the image capturing unit 5 provided for the tool 2 is a target arranged to be ready to be subjected to operations using the tool 2 which belongs to a plurality of targets preregistered with the tool 2, i.e., is a target on which the operations are going to be performed. In particular, when one of the plurality of targets is currently set in place, that target will be hereinafter sometimes referred to as a “current work target.” As used herein, the expression “the tool 2 is set in place on the target” refers to a situation where the tool 2 has been placed so as to be ready to perform operations on the target. Also, as used herein, the expression “the tool 2 is set in place on the target” refers to not only a situation where the tool 2 is already in contact with the target but also a situation where the tool 2 is on the verge of being brought into contact with the target, i.e., a situation where the tool 2 is now approaching the target. On the other hand, if the target is a workpiece to which a fastening member such as a bolt is to be attached and fastening operations including fastening a fastening member onto the target (i.e., the workpiece) are going to be performed, then the expression “the tool 2 is set in place on the target” may refer to either a situation where the fastening member held by the tip tool of the tool 2 is already in contact with the target (workpiece) or a situation where the fastening member held by the tip tool of the tool 2 is on the verge of being brought into contact with the target (i.e., the workpiece). That is to say, in the state where the tool 2 is set in place on the target, the tool 2 may be already in contact with the target or may be still out of contact with the target, whichever is appropriate. In the following description, a situation where the target of operations using the tool 2 is a workpiece to which a fastening member such as a bolt is to be attached will be described as an example.

Also, in the following description, a part of a workpiece, to which a fastening member is to be attached, will be hereinafter referred to as a “portion to be fastened.” For example, if the fastening member is a bolt, then the portion to be fastened will be a screw hole, into which the fastening member is screwed, and an area surrounding the screw hole. If a single workpiece has a plurality of such portions to be fastened, then each of a plurality of screw holes of the single workpiece and multiple areas surrounding those screw holes, respectively, will be the portion to be fastened and each of those portions to be fastened of a single workpiece will be the target of operations using the tool 2.

As used herein, the “captured image” refers to an image captured by the image capturing unit 5 and includes a still picture (still image) and a moving picture (motion picture). The “moving picture” further includes a group of still pictures (frames) captured by stop-motion shooting, for example. The captured image does not have to be output data itself provided by the image capturing unit 5. For example, the captured image may have been subjected, as needed, to data compression, conversion into another data format, cropping an image part from the image captured by the image capturing unit 5, focus adjustment, brightness adjustment, contrast adjustment, or any of various other types of image processing. In this embodiment, the captured image may be, for example, a full-color moving picture, for example.

Also, as used herein, if something is “provided for” something else, then the former may be built in (e.g., integrated inseparably with) the latter or may be just attached as an external member to the latter (e.g., removably secured with a coupler, for example). That is to say, the image capturing unit 5 provided for the tool 2 may be either built in the tool 2 or just attached as an external member to the tool 2, whichever is appropriate. The image capturing unit 5 is built in the tool 2 according to this embodiment.

The tool system 1 according to this embodiment includes a processor 35 and a start of operations detector 300. The processor 35 performs image processing on a captured image generated by the image capturing unit 5 and thereby performs identification processing including determining whether the work target matches any of one or more preregistered targets. Once the start of operations detector 300 detects a start of operations on the work target in a state where the work target is identified to be any of the one or more preregistered targets as a result of the identification processing, the processor 35 suspends the image processing on the captured image in the identification processing.

Once the tool 2 has started performing operations on the work target, there is no need to perform the identification processing to identify the work target. Thus, the power consumption of the tool system 1 may be cut down by suspending the image processing.

### (2) Specific Configuration

Next, a specific configuration for the tool system 1 according to this embodiment will be described with reference to FIGS. 1-3.

### (2.1) Premise

The tool system 1 according to this embodiment may be used, for example, on an assembly line for performing assembling operations on workpieces (targets) at a factory. In particular, in this embodiment, the tool 2 included in the tool system 1 is supposed to be a fastening tool such as an impact wrench for use to fasten a fastening member (such as a bolt or a nut). Specifically, this embodiment is supposed to be applied to a situation where a single workpiece has a plurality of portions to be fastened, thus requiring the user to attach a fastening member onto each of those portions to be fastened by using a tool 2 in a single workplace.

### (2.2) Configuration for Tool System

As shown in FIG. 1, the tool system 1 according to this embodiment includes the tool 2 and a work target identification system 10 for identifying a work target for the tool 2.

### (2.2.1) Configuration for Tool

First, a configuration for the tool 2 in the tool system 1 according to this embodiment will be described with reference to FIGS. 1-3. The tool 2 includes a control unit 3a, a driving unit 24, an impact mechanism 25, a notification unit 211, and a battery pack 201 (refer to FIG. 1).

The tool 2 according to this embodiment is an electric tool to activate the driving unit 24 with electrical energy. In particular, in this embodiment, the tool 2 is supposed to be an impact wrench. Such a tool 2 may be used to perform fastening operations including attaching a fastening member onto a work target.

In this case, the tool 2 is designed to activate the driving unit 24 with the electric power (electrical energy) supplied from the battery pack 201 by using the battery pack 201 as a power source. In this embodiment, the battery pack 201 is supposed to be one of the constituent elements of the tool 2. However, the battery pack 201 does not have to be a constituent element of the tool 2. In other words, the battery pack 201 may be counted out of the constituent elements of the tool 2.

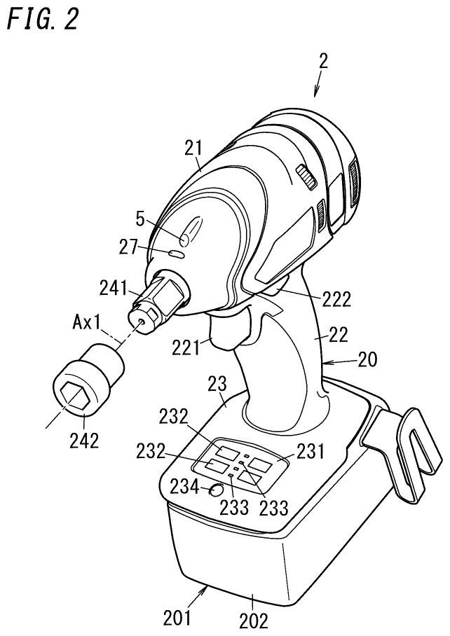

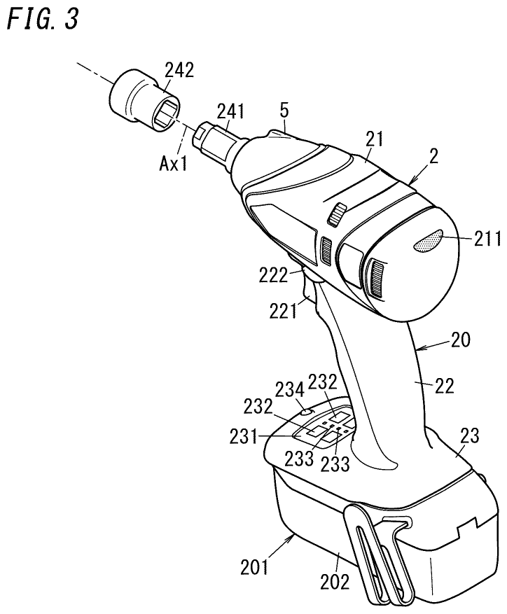

The tool 2 further includes a body 20 as shown in FIGS. 2 and 3. In the body 20, housed are the driving unit 24 and the impact mechanism 25. In addition, in the tool 2 according to this embodiment, the control unit 3a and the notification unit 211 are also housed in the body 20.

The body 20 of the tool 2 includes a barrel 21, a grip 22, and an attachment 23. The barrel 21 is formed in a cylindrical shape (e.g., circular cylindrical shape in this embodiment). The grip 22 protrudes along a normal to a part of the circumferential surface of the barrel 21 (i.e., along the radius of the barrel 21). To the attachment 23, the battery pack 201 is attached removably. In other words, the barrel 21 and the attachment 23 are coupled together via the grip 22.

At least the driving unit 24 is housed in the barrel 21. The driving unit 24 includes a motor. The driving unit 24 is configured to be activated with motive power that is the electric power supplied from the battery pack 201 as a power source to the motor. An output shaft 241 protrudes from one axial end surface of the barrel 21. The output shaft 241 rotates around a rotational axis Ax1, which is aligned with the direction in which the output shaft 241 protrudes, as the driving unit 24 is activated. That is to say, the driving unit 24 drives the output shaft 241 in rotation around the rotational axis Ax1. In other words, as the driving unit 24 is activated, torque is applied to the output shaft 241, thereby causing the output shaft 241 to rotate.

A cylindrical socket 242 for turning a fastening member (such as a bolt or a nut) is attached removably onto the output shaft 241. The socket 242 rotates along with the output shaft 241 around the rotational axis Ax1. The size of the socket 242 attached to the output shaft 241 may be selected as appropriate by the user according to the size of the fastening member. According to such a configuration, activating the driving unit 24 causes the output shaft 241 to rotate, thus causing the socket 242 to rotate along with the output shaft 241. If the socket 242 is fitted onto a fastening member at this time, then the fastening member turns along with the socket 242, thus having the operations of tightening or loosening the fastening member done. In this manner, the tool 2 may have the operations of tightening or loosening the fastening member done by activating the driving unit 24.

Optionally, a socket anvil may also be attached, instead of the socket 242, onto the output shaft 241. The socket anvil is also attached removably to the output shaft 241. This allows a bit (such as a screwdriver bit or a drill bit) to be attached to the output shaft 241 via the socket anvil.

The tool 2 includes the impact mechanism 25 as described above. The impact mechanism 25 is configured to, when (the work value of) fastening torque exceeds a predetermined level, apply impacting force in the rotational direction to the output shaft 241. This allows the tool 2 to apply greater fastening torque to the fastening member.

The grip 22 is a part to be gripped by the user while he or she is performing the operations. The grip 22 is provided with a trigger switch 221 (operating button) and a forward/reverse switch 222. The trigger switch 221 is a switch for controlling the ON/OFF states of the driving unit 24 to be activated or deactivated. The trigger switch 221 has an initial position and an ON position. When the trigger switch 221 is pressed or pulled by the user to the ON position, the driving unit 24 is activated. In addition, the trigger switch 221 allows for adjusting the degree of activation of the driving unit 24, i.e., the number of revolutions of the output shaft 241, according to how deep the trigger switch 221 is pulled (i.e., according to the manipulative variable of the trigger switch 221). The forward/reverse switch 222 is a switch for switching the rotational direction of the output shaft 241 from the clockwise direction to the counterclockwise direction, and vice versa.

The attachment 23 is formed in the shape of a compressed rectangular parallelepiped. The battery pack 201 is attached removably to one side, opposite from the grip 22, of the attachment 23.

The battery pack 201 includes a case 202 made of a resin and formed in a rectangular parallelepiped shape. The case 202 houses a rechargeable battery (such as a lithium-ion battery) inside. The battery pack 201 supplies electric power to the driving unit 24, the control unit 3a, the notification unit 211, the work target identification system 10, and other constituent members.

The attachment 23 is also provided with an operating panel 231. The operating panel 231 may include a plurality of press button switches 232 and a plurality of LEDs (light-emitting diodes) 233, for example. The operating panel 231 allows the user to enter various types of settings for, and confirm the status of, the tool 2, for example. That is to say, by operating the press button switches 232 of the operating panel 231, the user is allowed to change the operation mode of the tool 2 or check the remaining capacity (battery level) of the battery pack 201, for example.

The attachment 23 further includes a light-emitting unit 234 for shooting. The light-emitting unit 234 includes an LED, for example. The light-emitting unit 234 emits light toward the work target while the user is performing operations using the tool 2. The light-emitting unit 234 may be turned ON and OFF by operating the operating panel 231. Alternatively, the light-emitting unit 234 may also be lit automatically when the trigger switch 221 turns ON.

The notification unit 211 may be implemented as an LED, for example. The notification unit 211 is provided for the other end, opposite from the output shaft 241, of the barrel 21 of the body 20 so as to be easily recognized, with the eye, by the user during the operations (refer to FIG. 3).

The tool 2 according to this embodiment has, as its operation modes, at least a working mode and a registration mode. As used herein, the “working mode” refers to an operation mode in which the user performs operations using the tool 2. The registration mode herein refers to an operation mode in which a reference image corresponding to the work target is generated by using the tool 2. The operation mode may be switched by, for example, pressing the press button switches 232 and other members of the operating panel 231. Alternatively, the operation mode may also be switched by operating another member, such as the trigger switch 221 or a dip switch, provided separately from the operating panel 231. As used herein, the “reference image” refers to an image created based on the captured image generated by the image capturing unit 5. If there are multiple work targets, then a plurality of reference images may be created one to one for the plurality of work targets. Alternatively, a plurality of reference images may be created multiple to one for a single work target. Still alternatively, a plurality of reference images, created by shooting each of the plurality of work targets from various angles or in various sizes, may be associated with each of the plurality of work targets.

The control unit 3a includes, as a main constituent element, a microcontroller including one or more processors and one or more memories. The microcontroller performs the functions of the control unit 3a by making the one or more processors execute a program stored in the one or more memories. The program may be stored in advance in the memory. Alternatively, the program may also be distributed after having been stored in a non-transitory storage medium such as a memory card or downloaded via a telecommunications line. In other words, the program is designed to cause the one or more processors to serve as the control unit 3a.

The control unit 3a performs the functions of a driving controller 31, a notification controller 36, and a torque determiner 37, for example. Note that if no operating command is entered into the trigger switch 221 or the operating panel 231 for a certain period of time, the control unit 3a enters a sleep mode. The control unit 3a is booted when any operating command is entered, during the sleep mode, into either the trigger switch 221 or the operating panel 231.

The driving controller 31 controls the driving unit 24. Specifically, the driving controller 31 activates the driving unit 24 to cause the output shaft 241 to rotate at a rotational velocity determined by the press depth of the trigger switch 221 and in a rotational direction set by the forward/reverse switch 222. When the driving controller 31 drives the driving unit 24, the control unit 3a outputs a drive signal, indicating that the driving unit 24 is being driven, to the control unit 3b.

The driving controller 31 also controls the driving unit 24 to make the fastening torque equal to a preset torque value. The driving controller 31 has a torque estimating function of estimating the magnitude of the fastening torque. In this embodiment, the driving controller 31 estimates, until the estimated value of the fastening torque reaches a seating determination level, the magnitude of the fastening torque based on the number of revolutions or any other parameter of the driving unit 24 (motor). When the estimated value of the fastening torque reaches the seating determination level, the driving controller 31 estimates the magnitude of the fastening torque based on the number of strokes by the impact mechanism 25. When finding the number of stokes by the impact mechanism 25 has reached a threshold number of times based on the preset torque value, the driving controller 31 determines that the fastening torque should have reached the preset torque value, and stops running the driving unit 24 (i.e., the motor). This allows the tool 2 to fasten the fastening member with fastening torque that exactly matches the preset torque value. Optionally, the torque estimation function of the driving controller 31 may include obtaining an estimated value of the fastening torque either using a torque sensor or based on the value of a current flowing through the driving unit 24 (motor), whichever is appropriate.

The notification controller 36 controls the notification unit 211. The notification controller 36 preferably lights the notification unit 211 differently in a situation where the decision result of the identification processing performed by the processor 35 is disagreement from in a situation where the decision made by the processor 35 is agreement. For example, if the decision made by the processor 35 is disagreement, the notification controller 36 may light the notification unit 211 in red. On the other hand, if the decision made by the processor 35 is agreement, then the notification controller 36 may light the notification unit 211 in green. This allows the user to recognize, by checking the lighting state of the notification unit 211 with the eye, whether the work target matches any one of the plurality of preregistered targets or not. Optionally, when the trigger switch 221 is pulled in a state where the decision made by the processor 35 is disagreement, the notification controller 36 may light the notification unit 211. As can be seen, the tool system 1 includes the notification unit 211 that makes notification of the result of the identification processing, thus allowing the user to learn about the result of the identification processing.

Optionally, the identification processing to be performed by the processor 35 may include determining whether the work target matches the target determined by the procedure of operations. As used herein, the “procedure of operations” refers to the procedure of operations to be performed by using the tool 2. For example, if a series of operations to be performed on either a single work target or a plurality of work targets is defined to be a single process of operations, then the procedure of operations indicates the order in which the operations are to be performed on the single work target or a plurality of work targets in the process of operations. More specifically, if an operations instruction with respect to a single work target is defined to be an “operations instruction,” then the procedure of operations is a piece of information indicating a single or a plurality of operations instructions in the single process of operations along with their order. In other words, the procedure of operations indicates not only which of the single or plurality of work targets the operations that are going to be performed corresponds to in the single process of operations but also what the place of the operations that are going to be performed is in the single process of operations. In this embodiment, the procedure of operations may define, for example, in what order the operations are to be performed on a plurality of work targets included in a single workpiece. Note that if operations do not have to be performed on the plurality of work targets of the single workpiece as per the order defined by the procedure of operations, then the processor 35 does not have to determine whether the operations are being performed following the procedure of operations or not but may just determine whether the work target matches any one of the plurality of preregistered targets.

The torque determiner 37 is configured to determine whether or not the fastening torque is a normal one when the fastening member is attached to the portion to be fastened. In this case, the torque determiner 37 preferably determines, in accordance with the operations instruction defined by the procedure of operations, whether or not the fastening torque is a normal one. Specifically, the operations instruction defined by the procedure of operations includes a target torque value associated with the work target. This allows the torque determiner 37 to determine, by comparing the target torque value included in the operations instruction with the fastening torque estimated by the torque estimation function, whether or not the operations are being performed with the fastening torque specified by the operations instruction.

If the driving controller 31 has deactivated the driving unit 24 on detecting that the number of strokes by the impact mechanism 25 has reached the threshold number of times, for example, then the torque determiner 37 determines that the fastening torque should be normal. On the other hand, if the driving controller 31 has deactivated the driving unit 24 by turning the trigger switch 221 OFF before the number of strokes by the impact mechanism 25 reaches the threshold number of times, for example, then the torque determiner 37 determines that the fastening torque should be insufficient (abnormal). The torque determiner 37 also performs result storage processing of storing the decision results in a result storage device 43 in association with the portions to be fastened. Optionally, if the control unit 3a has determined, based on the decision result provided by the torque determiner 37, that operations on the work target have been done, then the control unit 3a may output an end-of-operations signal to the work target identification system 10 to make notification that the operations have been done.

### (2.2.2) Configuration for Work Target Identification System

Next, a configuration for the work target identification system 10 will be described with reference to FIGS. 1-3. The work target identification system 10 includes the image capturing unit 5, a control unit 3b, a storage unit 4, a tool movement detection unit 26, a distance measuring unit 27, and a pressed state detection unit 28.

The control unit 3b, the storage unit 4, the image capturing unit 5, the tool movement detection unit 26, the distance measuring unit 27, and the pressed state detection unit 28 are housed in the body 20 of the tool 2. In this embodiment, the image capturing unit 5 and the distance measuring unit 27 may be housed in the barrel 21, for example. The pressed state detection unit 28 is housed in a part, located closer to the rear surface (i.e., opposite from the surface with the trigger switch 221), of the grip 22. The control unit 3b, the storage unit 4, and the tool movement detection unit 26 are housed in either the grip 22 or the attachment 23.

The image capturing unit 5 is provided for the tool 2. The image capturing unit 5 generates a captured image by shooting the work target. In other words, the image capturing unit 5 generates data as the captured image. The image capturing unit 5 may be, for example, a camera including an image sensor and a lens. In this embodiment, the image capturing unit 5 may be housed in (the barrel 21 of) the body 20 of the tool 2 as described above. The image capturing unit 5 is provided to be oriented toward the tip of the output shaft 241 to capture an image of the work target while the user is performing operations using the tool 2. Thus, while the user is performing operations using the tool 2, the image capturing unit 5 generates a captured image by capturing an image of the work target.

Specifically, the image capturing unit 5 is provided for a tip portion of the barrel 21 to be oriented toward the tip of the output shaft 241 (i.e., toward the socket 242) such that the socket 242 attached to the output shaft 241 falls within the image capturing range (refer to FIGS. 2 and 3). The optical axis of the image capturing unit 5 is arranged to be aligned with the rotational axis Ax1 of the output shaft 241. In this embodiment, the image capturing unit 5 is arranged such that the optical axis thereof is located within a predetermined distance from the rotational axis Ax 1 of the output shaft 241 and that the rotational axis Ax1 and the optical axis are substantially parallel to each other. Note that the image capturing unit 5 does not have to generate the captured image such that the socket 242 attached to the output shaft 241 falls within the image capturing range thereof. Rather, the image capturing unit 5 only needs to generate a captured image for identifying the current work target. As used herein, the “captured image for identifying the current work target” refers to an image generated when the workpiece is shot by the image capturing unit 5 in a state where the tool 2 is currently set in place on the work target. According to the present disclosure, the work target (workpiece) on which the tool 2 is set in place is supposed to be shot in the captured image. The captured image has only to be an image that allows the user to identify the current work target. Thus, the work target on which the tool 2 is currently set in place does not have to fall within the image capturing range of the captured image.

The tool movement detection unit 26 detects, for example, the movement or orientation of the tool 2. The tool movement detection unit 26 may include, for example, a motion sensor 261 such as an acceleration sensor or a gyrosensor. In this embodiment, the tool movement detection unit 26 is housed in the (grip 22 or attachment 23 of the) body 20 of the tool 2 as described above. In this embodiment, the tool movement detection unit 26 includes, for example, a triaxial acceleration sensor and a triaxial gyrosensor as the motion sensors 261. The triaxial acceleration sensor detects acceleration in each of three axes that are perpendicular to each other and outputs an electrical signal representing the acceleration thus detected. The triaxial gyrosensor detects an angular velocity around each of three axes that are perpendicular to each other and outputs an electrical signal representing the angular velocity thus detected.

The tool movement detection unit 26 may detect the direction of gravitational force based on, for example, the output of the acceleration sensor and detect, for example, the orientation of the tool 2 by reference to the direction of gravitational force. In addition, the tool movement detection unit 26 may also detect, based on the output of the gyrosensor, the angular velocity of the tool 2 that is moving while rotating and further detect, based on the integral result of the angular velocity, the rotational angle of the tool 2, for example. For instance, the tool movement detection unit 26 may detect such an orientation of the tool 2 that makes the direction in which the grip 22 protrudes from the barrel 21 downward (corresponding to the direction of gravitational force) and such an orientation of the tool 2 that makes the direction in which the grip 22 protrudes from the barrel 21 upward distinguishably from each other. As used herein, the “orientation of the tool 2” refers to the orientation of the tool 2 which is determined by the respective rotational angles (e.g., the roll, pitch, and yaw angles) around the three axes with respect to the direction of gravitational force as the reference, for example. The tool movement detection unit 26 detects the movement and orientation of the tool 2 based on the outputs of the motion sensors 261 (including the acceleration sensor and the gyrosensor) and provides the results of detection as movement information about the movement and orientation of the tool 2 to the set state detector 34 of the control unit 3b.

The distance measuring unit 27 measures the distance between the tool 2 and the work target. The distance measuring unit 27 includes, for example, a distance sensor 271 such as a radio detection and ranging (RADAR) sensor, a light detection and ranging (LiDAR) sensor, or an ultrasonic sensor. The LiDAR sensor may be an infrared sensor, for example. In this embodiment, the distance measuring unit 27 is housed in the (barrel 21 of the) body 20 of the tool 2 as described above. Specifically, the distance measuring unit 27, as well as the image capturing unit 5, is provided for a tip portion of the barrel 21 to be oriented toward the tip of the output shaft 241 (i.e., toward the socket 242). In this embodiment, the distance measuring unit 27 includes an ultrasonic sensor, for example. The ultrasonic sensor is a time-of-flight distance sensor for measuring the distance to the workpiece (as a work target) by emitting an ultrasonic wave toward the workpiece (as a work target) and measuring the time it takes for the ultrasonic wave reflected from the workpiece (as a work target) to be received. The ultrasonic sensor outputs an electrical signal representing the distance thus measured.

The distance measuring unit 27 detects, based on the output of the distance sensor 271, the distance between the workpiece (as a work target) and the tool 2. The distance measuring unit 27 outputs the result of detection, as distance information about the distance between the tool 2 and the work target, to the set state detector 34 of the control unit 3b.

The pressed state detection unit 28 detects a pressed state, i.e., a state where the tool 2 is pressed against the work target. In this embodiment, the pressed state detection unit 28 is housed in a part, closer to the rear surface, of the (grip 22 of the) body 20 of the tool 2 as described above. The pressed state detection unit 28 according to this embodiment includes a pressure sensor 281 which uses, for example, a metal strain gauge or a semiconductor strain gauge. The pressure sensor 281 detects the pressure applied to the rear surface of the grip 22 and outputs an electrical signal representing the pressure thus detected.

The pressed state detection unit 28 detects, based on the output of the pressure sensor 281, that the tool 2 is pressed against the work target. In this case, the force applied to the rear surface of the grip 22 while the tool 2 is being pressed by the user against the work target is greater than the force applied to the rear surface of the grip 22 while the user is carrying the tool 2 with him or her, for example. Thus, the pressed state detection unit 28 detects, when finding the pressure detected by the pressure sensor 281 equal to or greater than a first threshold pressure, that the tool 2 is pressed against the work target. The pressed state detection unit 28 outputs the result of detection, as information about the press of the tool 2, to the set state detector 34 of the control unit 3b.

The control unit 3b includes, as a main constituent element, a microcontroller including one or more processors and one or more memories. The microcontroller performs the functions of the control unit 3b by making the one or more processors execute a program stored in the one or more memories. The program may be stored in advance in the memory. Alternatively, the program may also be distributed after having been stored in a non-transitory storage medium such as a memory card or downloaded via a telecommunications line. In other words, the program is designed to cause the one or more processors to serve as the control unit 3b.

The control unit 3b performs the functions of an image capturing controller 32, the stability determiner 33, the set state detector 34, the processor 35, a registerer 38, a driving detector 39, and a start of operations detector 300, for example. Note that if no operating command is entered into the trigger switch 221 or the operating panel 231 for a certain period of time, the control unit 3b enters a sleep mode. The control unit 3b is booted when any operating command is entered, during the sleep mode, into either the trigger switch 221 or the operating panel 231.

The image capturing controller 32 is configured to control the image capturing unit 5. When the control unit 3b is booted, the image capturing controller 32 according to this embodiment makes the image capturing unit 5 start performing an image capturing operation.

The stability determiner 33 determines whether the captured image generated by the image capturing unit 5 is stabilized or not. The stability determiner 33 according to this embodiment performs, while the tool 2 is operating in the working mode, stability determination processing of determining, based on a plurality of frames included in the captured image, whether the captured image is stabilized or not. As used herein, the expression “the captured image is stabilized” may refer to a situation where the image capturing unit 5 has captured a non-blurry image with the tool 2 set in place on the work target. In addition, the expression “the captured image is stabilized” may also refer to a situation where the image capturing unit 5 has captured an image with image capturing control such as automatic exposure (AE) and auto white balance (AWB) stabilized.

The stability determiner 33 according to this embodiment calculates the degree of difference between a plurality of frames and determines, when finding the degree of difference equal to or less than a threshold value, that the captured image be stabilized. Specifically, the stability determiner 33 calculates the degree of difference between the latest frame (current frame) included in the captured image and the previous (past) frame preceding the latest frame. In the following description, the latest frame included in the captured image will be hereinafter sometimes referred to as a “first frame” and the frame preceding the latest frame will be hereinafter sometimes referred to as a “second frame.” The stability determiner 33 calculates the degree of difference as the difference between a luminance value (which may be a density value or a grayscale value) in a particular area in the first frame and a luminance value (which may be a density value or a grayscale value) in its corresponding particular area in the second frame. The stability determiner 33 calculates the degree of difference using, for example, a sum of squared differences (SSD) or a sum of absolute differences (SAD). In this case, the particular area in the first and second frames may be, for example, an area defined in advance by coordinates in the captured image. The particular area in the first frame and the particular area in the second frame have the same set of coordinates. Also, the number of the particular area(s) defined in the first and second frames needs to be at least one but is preferably plural in order to increase the accuracy of the stability determination processing.

The stability determiner 33 compares the degree of difference with a threshold value and determines, when finding the degree of difference equal to or less than the threshold value, that the captured image be stabilized. When determining that the captured image be stabilized, the stability determiner 33 outputs stability information to the set state detector 34 and the processor 35. On the other hand, when finding the degree of difference greater than the threshold value, the stability determiner 33 does not determine that the captured image be stabilized. When not determining that the captured image be stabilized, the stability determiner 33 does not output stability information to the set state detector 34 or the processor 35.

The driving detector 39 detects an activated state of the driving unit 24. The driving detector 39 may detect, in response to a drive signal supplied from the control unit 3a, for example, that the driving unit 24 is activated. On detecting that the driving unit 24 is activated, the driving detector 39 outputs driving information to the start of operations detector 300 and the processor 35.

The set state detector 34 detects a state where the tool 2 is set in place on the work target. The set state detector 34 according to this embodiment performs, when the tool 2 is operating in the working mode, detection processing of determining whether the tool 2 is set in place on the work target or not.

The set state detector 34 according to this embodiment detects, in accordance with movement information provided by the tool movement detection unit 26, distance information provided by the distance measuring unit 27, and pressed state information provided by the pressed state detection unit 28, the state where the tool 2 is set in place on the work target.

The set state detector 34 determines, in accordance with the movement information provided by the tool movement detection unit 26, whether the tool 2 is set in place on the work target. If the tool's 2 orientation detected by the tool movement detection unit 26 is a predetermined orientation, then the set state detector 34 detects the state where the tool 2 is set in place on the work target. As used herein, the “predetermined orientation” may refer to, for example, an orientation of the tool 2, of which an angular difference from a reference orientation is equal to or less than a threshold value when the tool's 2 orientation is compared with the reference orientation. Specifically, the predetermined orientation refers to an orientation of the tool 2 in a situation where either the sum or average of the differences between the tool's 2 rotational angles detected around the three axes by the tool movement detection unit 26 and its rotational angles defined around the three axes with respect to the reference orientation is equal to or less than a threshold value. Also, the “reference orientation” as used herein refers to such an orientation of the tool 2 that makes the direction in which the grip 22 protrudes from the barrel 21 downward (corresponding to the direction of gravitational force). The set state detector 34 according to this embodiment determines, when finding the average of the differences between the tool's 2 rotational angles detected around the three axes by the tool movement detection unit 26 and its rotational angles defined around the three axes with respect to the reference orientation is equal to or less than 5 degrees, that the tool 2 have the predetermined orientation. Note that the “average of the differences between the tool's 2 rotational angles detected around the three axes by the tool movement detection unit 26 and its rotational angles defined around the three axes with respect to the reference orientation” will be hereinafter sometimes simply referred to as the “angular difference between the tool's 2 orientation and its reference orientation.” That is to say, the set state detector 34 according to this embodiment detects, when finding the average of the differences between the tool's 2 rotational angles detected around the three axes by the tool movement detection unit 26 and its rotational angles defined around the three axes with respect to the reference orientation equal to or less than 5 degrees, the state where the tool 2 is set in place on the work target. Alternatively, the set state detector 34 may set it as one of the conditions for detecting the state where the tool 2 is set in place on the work target that the average of the differences between the tool's 2 rotational angles detected around the three axes by the tool movement detection unit 26 and its rotational angles defined around the three axes with respect to the reference orientation be equal to or less than 5 degrees. Note that the reference orientation may be changed as appropriate according to, for example, the orientation of the workpiece as the work target.

In addition, the set state detector 34 also determines, in accordance with the distance information provided by the distance measuring unit 27, whether the tool 2 is set in place on the work target. Specifically, the set state detector 34 detects, when finding the distance detected by the distance measuring unit 27 between the tool 2 and the work target falling within a preset range, the state where the tool 2 is set in place on the work target. Alternatively, the set state detector 34 may set it as one of the conditions for detecting the state where the tool 2 is set in place on the work target that the distance between the tool 2 and the work target fall within the preset range. As used herein, the situation where “the distance between the tool 2 and the work target falls within the preset range” refers to a situation where the absolute value of the difference calculated by subtracting the distance detected by the distance measuring unit 27 between the tool 2 and the work target from a reference distance is equal to or less than a threshold distance. As used herein, the “reference distance” refers to a distance defined as a reference for the set state detector 34 to detect the state where the tool 2 is set in place on the work target. The reference distance may be, for example, the distance detected by the distance measuring unit 27 between the tool 2 and the work target when a reference image is captured and is associated with the reference image. Also, the reference distance may be somewhat longer than the distance between the distance sensor 271 of the distance measuring unit 27 and the tip of the socket 242. Note that the absolute value of the difference calculated by subtracting the distance detected by the distance measuring unit 27 between the tool 2 and the work target from the reference distance will be hereinafter sometimes simply referred to as a “distance difference.”

Furthermore, the set state detector 34 also determines, in accordance with the pressed state information provided by the pressed state detection unit 28, whether the tool 2 is set in place on the work target. Specifically, the set state detector 34 detects, when finding the value of the pressure applied to the rear surface of the grip 22 as detected by the pressed state detection unit 28 equal to or greater than a first threshold pressure, the state where the tool 2 is set in place on the work target. Alternatively, the set state detector 34 may set it as one of the conditions for detecting the state where the tool 2 is set in place on the work target that the value of the pressure applied to the rear surface of the grip 22 be equal to or greater than the first threshold pressure.

Furthermore, the set state detector 34 according to this embodiment further determines, based on the press depth of the trigger switch 221, whether the tool 2 is set in place on the work target. Specifically, the set state detector 34 detects, when finding the trigger switch 221 pressed halfway by the user, the state where the tool 2 is set in place on the work target. As used herein, the phrase “pressed halfway” refers to a state where the trigger switch 221 has been pressed halfway between the initial position and the ON position. Specifically, to be “pressed halfway” herein refers to a state where the trigger switch 221 has been pressed to approximately an intermediate level between the initial position and the ON position. The set state detector 34 detects, when finding the trigger switch 221 pressed halfway between the initial position and the ON position, the state where the tool 2 is set in place on the work target. Alternatively, the set state detector 34 may set it as one of the conditions for detecting the state where the tool 2 is set in place on the work target that the trigger switch 221 have been pressed halfway between the initial position and the ON position.

Furthermore, the set state detector 34 according to this embodiment also detects, upon acquiring the stability information from the stability determiner 33 (i.e., when the stability determiner 33 has determined that the captured image be stabilized), the state where the tool 2 is set in place on the work target. Alternatively, the set state detector 34 may set it as one of the conditions for detecting the state where the tool 2 is set in place on the work target that the stability determiner 33 have determined that the captured image be stabilized.

Upon detecting the state where the tool 2 is set in place on the work target, the set state detector 34 outputs set state detection information to the processor 35. On the other hand, unless the set state detector 34 detects the state where the tool 2 is set in place on the work target, the set state detector 34 outputs no set state detection information to the processor 35.

The set state detector 34 according to this embodiment detects the state where the tool 2 is set in place on the work target, when the tool's 2 current orientation is the predetermined orientation, the distance difference is equal to or less than the threshold distance, the value of the pressure applied to the rear surface of the grip 22 is equal to or greater than the first threshold pressure, the stability determiner 33 has determined that the captured image be stabilized, and the trigger switch 221 has been pressed halfway. Note that the set state detector 34 according to this embodiment does not detect, when not finding the tool's 2 current orientation to be the predetermined orientation, the state where the tool 2 is set in place on the work target. Also, the set state detector 34 according to this embodiment does not detect, when finding the distance difference greater than the threshold distance, the state where the tool 2 is set in place on the work target. Furthermore, the set state detector 34 according to this embodiment does not detect, when finding the value of the pressure applied to the rear surface of the grip 22 less than the first threshold pressure, the state where the tool 2 is set in place on the work target. Furthermore, the set state detector 34 according to this embodiment does not detect, unless the stability determiner 33 determines that the captured image be stabilized, the state where the tool 2 is set in place on the work target. Furthermore, the set state detector 34 according to this embodiment does not detect, unless the trigger switch 221 has been pressed halfway, the state where the tool 2 is set in place on the work target.

The start of operations detector 300 determines whether the tool 2 has started performing operations on the work target. If the tool 2 is operating in the working mode, then the start of operations detector 300 performs the detection processing including determining whether the tool 2 has started performing operations on the work target with the state where the tool 2 is set in place on the work target detected by the set state detector 34.

For example, the start of operations detector 300 detects, in response to an input signal supplied from an operating button operated at the start of operations, for example, that the operations have been started. Making the user operate the operating button when starting performing operations allows the start of operations detector 300 to detect the start of the operations. As such an operating button, the trigger switch 221 to activate the driving unit 24 with a manipulative variable corresponding to the pull depth may be used, for example. When the trigger switch 221 has been operated by the user to the ON position with the tool 2 set in place on the work target, the start of operations detector 300 detects that the tool 2 has started performing operations on the work target. Note that the operating button does not have to be the trigger switch 221 but may also be a button different from the trigger switch 221. For example, the operating button may also be implemented as a press button switch provided at a position where the user may put his or her hand on the button when performing operations using the tool 2.

Optionally, when receiving driving information from the driving detector 39 in a state where the tool 2 is set in place on the work target, the start of operations detector 300 may detect that the tool 2 has started performing operations on the work target. That is to say, the start of operations detector 300 may detect the start of the operations, based on the result of detection obtained by the driving detector 39. The start of operations detector 300 may detect the start of operations on the work target with reliability now that the driving unit 24 is activated.

Also, when the pressed state detection unit 28 detects the pressed state after the work target on which the tool 2 has been set in place has been identified, the start of operations detector 300 may detect the start of the operations on the work target. Since the pressed state persists after the work target has been identified by the identification processing, the start of operations detector 300 may determine that the operations on the work target have been started. Furthermore, when the pressure detected by the pressure sensor 281 included in the pressed state detection unit 28 becomes equal to or higher than a predetermined second threshold pressure in a state where the tool 2 is set in place on the work target, the start of operations detector 300 may detect the start of operations on the work target. The second threshold pressure is pressure generated while fastening operations are being performed with the tool 2. The second threshold pressure is set at a higher pressure value than the first threshold pressure.

Note that the start of operations detector 300 may detect the start of the operations on the work target if the start of operations detector 300 receives the driving information from the driving detector 39, if the trigger switch 221 is pulled by the user to the ON position, or if the value of the pressure applied to the work target is equal to or higher than the second threshold pressure in a state where the tool 2 has been set in place on the work target.

The processor 35 according to this embodiment performs, upon receiving at least one of the stability information provided by the stability determiner 33 or the set state detection information provided by the set state detector 34, predetermined processing based on the captured image. In other words, the processor 35 performs the identification processing based on the captured image when the work target is highly likely to be identified successfully. If the processor 35 started performing the identification processing too early, then not just would the work target fail to be identified but also would the identification processing fail to be started at the timing when the user is ready to start doing the operations with the tool 2 held in his or her hands. This is because it takes 0.5 seconds to 1.0 second to have the identification processing done by the processor 35. If the identification processing failed to be started at the timing when the user is ready to start doing the operations with the tool 2 held in his or her hands, a significant delay would be caused when the identification processing is finished, thus possibly disturbing the user's work rhythm. In contrast, the processor 35 according to this embodiment may perform the identification processing when the work target is highly likely to be identified successfully, i.e., at the best timing when the user is ready to start doing the operations with the tool 2 held in his or her hands, thus reducing the chances of causing a significant delay when the identification processing is finished. In addition, the identification processing may be performed based on a captured image on which an image capturing control such as AE or AWB has been performed with stability by the image capturing unit 5, thus contributing to improving the accuracy of the identification processing. Note that if the processor 35 according to this embodiment has not received at least one of the stability information provided by the stability determiner 33 or the set state detection information provided by the set state detector 34, then the processor 35 according to this embodiment does not perform the predetermined processing based on the captured image.

The processor 35 intermittently performs, as the predetermined processing, the identification processing of identifying a current work target, on which the tool 2 is currently set in place, among the plurality of work targets. That is to say, the processor 35 has the function of identifying the current work target shot in the captured image. Specifically, the processor 35 performs image processing of comparing the captured image generated by the image capturing unit 5 with a plurality of reference images, thereby identifying the current work target shot in the captured image among the plurality of targets. In this case, the plurality of reference images are stored in the storage unit 4 (image storage device 41). As used herein, the term “intermittently” refers to not only a situation where some event occurs at regular intervals but also a situation where the event occurs at irregular intervals as well. Therefore, the phrase “performing identification processing intermittently” means not only performing the identification processing at regular intervals but also performing the identification processing at irregular intervals as well.

Specifically, the processor 35 performs, on the captured image, pattern recognition processing using, as template data, a plurality of reference images corresponding to the plurality of targets, thereby identifying the current work target. That is to say, the processor 35 identifies the current work target shot in the captured image by comparing the captured image with the plurality of reference images corresponding to the plurality of targets.

As used herein, the “pattern recognition processing” refers to image processing for recognizing, based on the shape of an object shot in an image, what the object shot in the image is. Examples of the pattern recognition processing of this type include pattern matching processing and processing of recognizing an object shot in an image by using a learned model created by machine learning. The pattern matching processing as used herein refers to the processing of using the above-described template data to compare the template data with a target (such as the captured image). Also, any appropriate algorithm may be used in the method for machine learning. For example, a deep learning algorithm may be adopted.

Furthermore, if the work target thus identified does not conform to an operations instruction defined by the procedure of operations, then the processor 35 performs at least one of placing a restriction on the activation of the driving unit 24 or making notification. In other words, the processor 35 determines whether or not the work target identified by the processor 35 (i.e., the current work target) conforms to an operations instruction defined by the preset procedure of operations. That is to say, the processor 35 determines whether or not the work target identified by the processor 35 matches the work target specified by the operations instruction included in the procedure of operations.

Specifically, the processor 35 extracts data about a procedure of operations associated with the current work target from a procedure storage device 44 of the storage unit 4. Then, the processor 35 determines whether or not the work target, subjected to the current operations instruction defined by the procedure of operations that has been extracted from the procedure storage device 44, matches the work target identified. If these work targets match each other, the processor 35 determines that the work target identified conform to the operations instruction defined by the procedure of operations. On the other hand, if these work targets do not match each other, the processor 35 determines that the work target identified does not conform to the operations instruction defined by the procedure of operations.

When determining, as a result of such determination, that the work target thus identified does not conform to the operations instruction defined by the procedure of operations, the processor 35 performs at least one of placing a restriction on the activation of the driving unit 24 or making notification. As used herein, the “notification” refers to not only that the user is notified directly by the notification unit 211 of the tool system 1 but also that the user is notified indirectly via an external terminal (such as a mobile communications device), for example.

Specifically, when determining that the work target thus identified does not conform to the operations instruction defined by the procedure of operations specified, the processor 35 does not allow the driving unit 24 to be activated even if the trigger switch 221 is pulled. That is to say, the driving unit 24 is allowed to be activated only when the processor 35 determines that the work target thus identified conform to the operations instruction defined by the procedure of operations. Thus, even if the tool 2 is currently set in place on a work target that does not conform to the procedure of operations, the driving unit 24 remains deactivated, thus prohibiting fastening operations from being performed. This may reduce the chances of the operations being performed in a wrong procedure of operations. Optionally, when determining that the work target thus identified does not conform to the operations instruction defined by the procedure of operations, the processor 35 may lock the trigger switch 221 to prevent the user from pulling the trigger switch 221 in such a situation.

In addition, when determining that the work target thus identified does not conform to the operations instruction defined by the procedure of operations, the processor 35 makes the notification controller 36 activate the notification unit 211. Thus, the notification unit 211 serves as a user notification unit for notifying the user that the tool 2 is now set in place on a work target that does not conform to the procedure of operations.

That is to say, on receiving at least one of the stability information provided by the stability determiner 33 or the set state detection information provided by the set state detector 34, the processor 35 performs, as predetermined processing, at least identification processing of identifying the current work target. In addition, the processor 35 further performs, as predetermined processing, procedure determination processing of comparing the work target thus identified with the operations instruction defined by the procedure of operations and thereby determining their correspondence. If the result of the procedure determination processing reveals that the work target does not conform to the operations instruction, then the processor 35 places a restriction on the activation of the driving unit 24 and/or makes notification.

Also, on receiving the start of operations detection information from the start of operations detector 300 with the work target already identified, the processor 35 suspends the image processing on the captured image in the identification processing. There is no need to perform the identification processing of identifying the work target once the operations on the work target have been started. Thus, the power consumption of the tool 2 may be cut down by making the processor 35 suspend the image processing on the captured image in the identification processing. Alternatively, on receiving the start of operations detection information from the start of operations detector 300 with the work target already identified, the processor 35 may suspend not only the identification processing but also the image capturing processing by the image capturing unit 5 as well. Still alternatively, on receiving the start of operations detection information from the start of operations detector 300 with the work target already identified, the processor 35 may suspend not only the identification processing but also setting the specifics of operations (e.g., setting a target torque value) with respect to the work target identified by the identification processing as well. This may reduce the chances of the settings of the specifics of operations on the work target from being changed by mistake while the operations are being performed using the tool 2.

The registerer 38 performs, if the operation mode of the tool 2 is the registration mode, image registration processing of storing the plurality of reference images in the image storage device 41 of the storage unit 4 and torque registration processing of storing a plurality of target torque values in the torque storage device 42 of the storage unit 4.

In addition, the registerer 38 makes, while performing the image registration processing, the image storage device 41 store, as the reference image, a still picture generated by having the work target shot by the image capturing unit 5, for example. Specifically, if the operation mode of the tool 2 is the registration mode, then the trigger switch 221 also serves as a shutter release button. When the trigger switch 221 turns ON (i.e., has been pressed to the ON position), the image capturing unit 5 generates a still picture. The registerer 38 makes the image storage device 41 store this still picture as a reference image.

The storage unit 4 may be implemented as a semiconductor memory, for example, and performs the function of the image storage device 41, the torque storage device 42 (target value storage device), the result storage device 43, and the procedure storage device 44. In this embodiment, the image storage device 41, the torque storage device 42, the result storage device 43, and the procedure storage device 44 are implemented as a single memory. However, this is only an example and should not be construed as limiting. Alternatively, these storage devices 41, 42, 43, and 44 may also be implemented as a plurality of memories. Still alternatively, the storage unit 4 may also be implemented as a storage medium such as a memory card to be attached removably to the tool 2. Furthermore, if the tool 2 has communications capabilities that allow the tool 2 to be connected to a network, then the storage unit 4 may also be implemented as a data server on the network.

The image storage device 41 stores the plurality of reference images in association with the plurality of targets.

The torque storage device 42 stores, one to one, a plurality of target torque values (target values) in association with the plurality of targets. As used herein, the “target torque value” refers to the target value of fastening torque when a fastening member is attached to an associated target.

The result storage device 43 stores the decision results obtained by the torque determiner 37 with respect to a plurality of portions to be fastened in association with the plurality of targets (work targets). It is recommended that the result storage device 43 store the decision results obtained by the torque determiner 37 with time stamps, indicating the operations times, added thereto. This allows the decision results about a plurality of portions to be fastened of the target (work target) to be distinguished from each other in each of a plurality of targets (i.e., workpieces as work targets) on an assembly line.

The procedure storage device 44 stores data about either a single procedure of operations or a plurality of procedures of operations. As described above, the procedure of operations means the procedure in which operations are supposed to be performed using the tool 2 and may be, for example, data defining in what order the operations should be performed on a plurality of targets of a single workpiece.

### (3) How Tool System Works

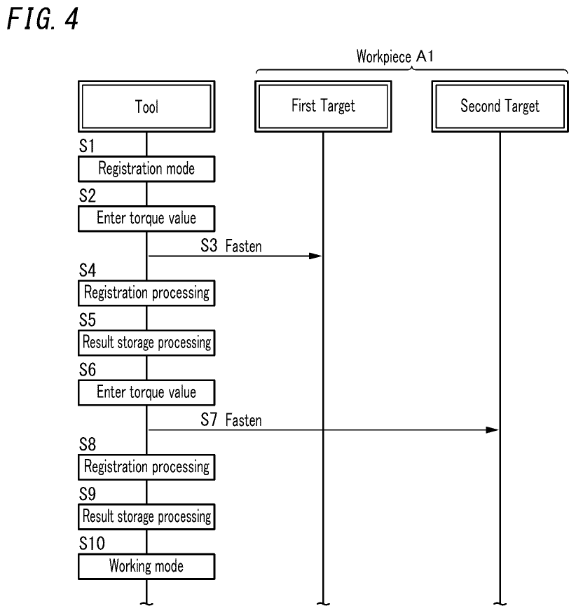

Next, it will be described with reference to FIGS. 4-7 how the tool system 1 according to this embodiment works.

In the following example, it will be described how the tool system 1 works when the user performs the operations of assembling a plurality of workpieces Al on an assembly line. Each workpiece A1 is supposed to have two portions to be fastened (hereinafter referred to as a “first portion to be fastened” and a “second portion to be fastened,” respectively). In the following description, the first and second portions to be fastened of a single workpiece Al will be hereinafter referred to as “targets (namely, a ”first target“ and a ”second target,“ respectively).” The user is supposed to perform the operations of attaching a fastening member onto each of these targets using the tool 2. In the following description, a situation where operations on a plurality of work targets are supposed to be performed in the order defined by the procedure of operations will be described as an example. However, this is only an example and should not be construed as limiting. Alternatively, the operations on the plurality of work targets may also be performed in an arbitrary order.

### (3.1) Registration Mode

First, it will be described with reference to FIG. 4 how the tool system 1 may work in the registration mode. In this case, the tool 2 is supposed to be in an initial state in which neither the image registration processing nor the torque registration processing has been performed yet by the registerer 38. That is to say, in the tool 2 in the initial state, none of the first and second reference images and first and second target torque values corresponding to the first and second targets, respectively, are stored in the image storage device 41 or the torque storage device 42, respectively, yet.

The user sets the operation mode of the tool 2 at the registration mode (in S1). Next, the user operates the operating panel 231 to enter the torque value of the fastening torque when a fastening member is attached to the first target (i.e., the first portion to be fastened of the workpiece A1) (in S2). The driving controller 31 sets the entered torque value as a preset torque value for the first target. Then, the user sets the tool 2 on the first target (work target) to perform the fastening operations of attaching the fastening member onto the first target by pulling the trigger switch 221 (in S3). At this time, the first target as the work target is shot, thus generating a still image of the first target.

When the fastening operations are done, the registerer 38 performs registration processing (including image registration processing and torque registration processing) (in S4). Specifically, the registerer 38 performs the image registration processing of making the image storage device 41 store, as a first reference image corresponding to the first target, a still picture of the first target generated during the fastening operations in Step S3. In addition, the registerer 38 also performs the torque registration processing of making the torque storage device 42 store, as a first target torque value associated with the first target, a preset torque value when the fastening member is attached to the first target as a work target during the fastening operations in Step S3. That is to say, the first target torque value is stored in association with the first reference image.

In particular, according to this embodiment, the processor 35 performs the procedure determination processing. Thus, in the registration processing, the target torque value is registered to be included in the operations instruction. In other words, in the registration processing, the procedure of operations is registered. In this example, the registerer 38 registers the procedure of operations such that the operations instruction instructing the operations to be performed on the first target becomes the first operations instruction in the procedure of operations. Specifically, the registerer 38 registers, as the operations process step to be performed “in the first place” according to the procedure of operations, an operations instruction which instructs the operations to be performed on the first target and which includes the first target torque value.

The torque determiner 37 performs result storage processing of making the result storage device 43 store, in association with the first target, a first decision result indicating whether the fastening torque when the fastening member is attached to the first work target is a normal one or not (in S5).

In addition, the user also performs fastening operations on the second target following the same procedure of operations for the first target as a work target. Specifically, the user operates the operating panel 231 to enter a torque value of fastening torque when a fastening member is attached to the second target (in S6) and then performs the fastening operations of attaching the fastening member to the second target with the tool 2 set in place on the second target (in S7). At this time, a still picture of the second target as a work target is generated and the registerer 38 performs the registration processing (including the image registration processing and the torque registration processing) (in S8). The registerer 38 registers, as an operations process step to be performed “in the second place” according to the procedure of operations, an operations instruction which instructs the operations to be performed on the second target and which includes a second target torque value. The torque determiner 37 performs result storage processing of making the result storage device 43 store a second decision result indicating whether the fastening torque during the fastening operations in Step S7 is a normal one or not (in S9).

When the registration processing is done on every target (i.e., every portion to be fastened) of the workpiece A1, the user operates the operating panel 231 to change the operation mode of the tool 2 from the registration mode to the working mode (in S10). Changing the operation mode of the tool 2 from the registration mode to the working mode ends the registration mode.

Note that the sequence shown in FIG. 4 is only an example. Thus, the processing steps shown in FIG. 4 may be performed in a different order as appropriate; an additional processing step may be performed as needed, or at least one of the processing steps may be omitted as appropriate.

### (3.2) Working Mode

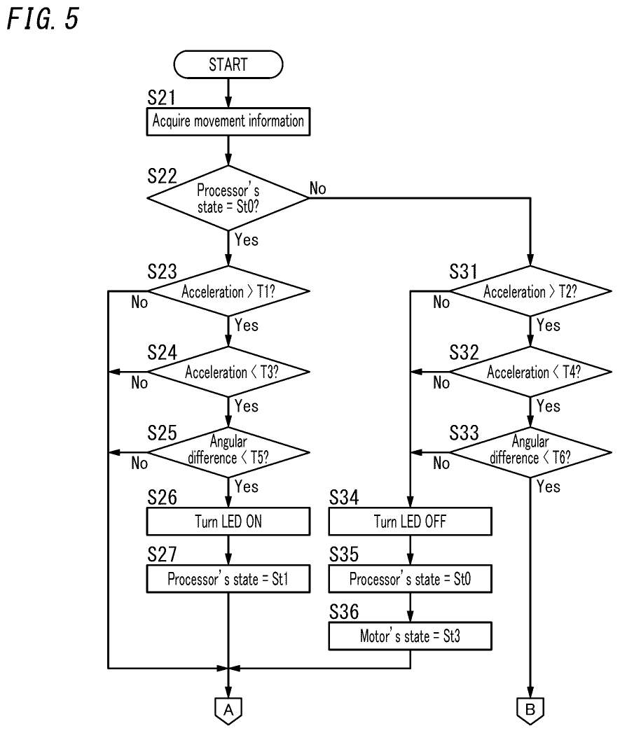

Next, it will be described with reference to FIGS. 5-7 how the tool system 1 may work in the working mode.

The processing shown in FIGS. 5-7 is performed by the tool system 1 every time a frame of the captured image generated by the image capturing unit 5 is refreshed. When a frame of the captured image is refreshed, the set state detector 34 acquires the movement information from the tool movement detection unit 26 (in S21). Next, the set state detector 34 sees if the (operating) state of the processor 35 is state St0 (in S22). As used herein, the “state St0” refers to an idle state of the processor 35 in which the identification processing is not started. On the other hand, a state “St1” as used herein refers to a standby state of the processor 35 in which the identification processing has not been started yet but may possibly be started. Furthermore, a state “St2” as used herein refers to a state where the processor 35 is performing the identification processing.

If the state of the processor 35 is the state St0 (if the answer is YES in S22), the set state detector 34 compares the acceleration of the tool 2 with an acceleration threshold value T1 based on the movement information (in S23). In this case, the acceleration threshold value T1 according to this embodiment is approximately equal to zero. The threshold value T1 is set at a value smaller than a minimum value of acceleration that would be produced while the tool 2 is moving. That is to say, the set state detector 34 sees if the tool 2 is moving at least slightly. In other words, the set state detector 34 sees if the tool 2 is not put on a desk or a floor, for example. It is apparent that the state where the tool 2 is put on a desk or a floor is different from the state where the tool 2 is set in place on the work target. When finding the acceleration of the tool 2 greater than the threshold value T1 (if the answer is YES in S23), the set state detector 34 compares the acceleration of the tool 2 with another acceleration threshold value T3 based on the movement information (in S24). In this case, the acceleration threshold value T3 according to this embodiment is a value larger than the threshold value T1 and is set at a value close to the acceleration of the tool 2 in a situation where the user is moving while carrying the tool 2 with him or her (i.e., in a situation where the user is shaking the tool 2). It is apparent that the state where the user is moving while carrying the tool 2 with him or her or the state where the user is shaking the tool 2 is not the state where the tool 2 is set in place on the work target.

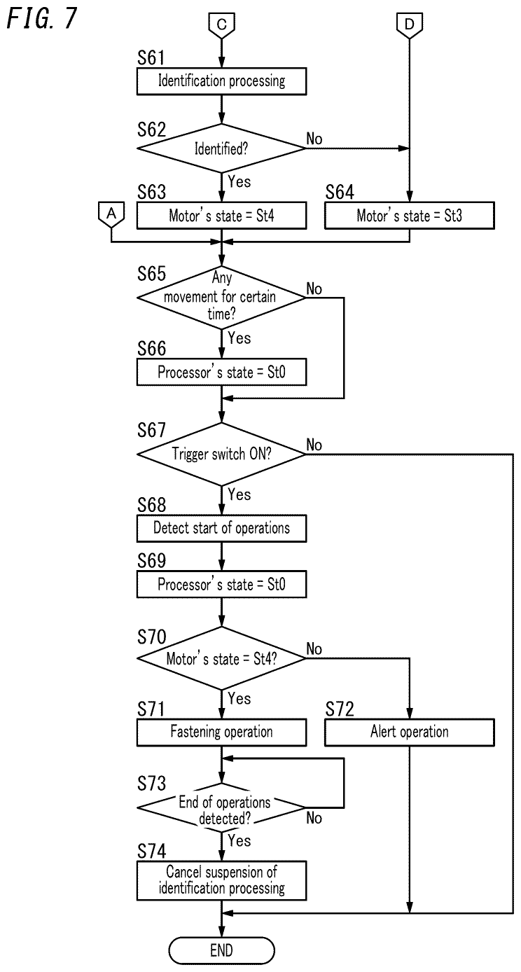

When finding the acceleration of the tool 2 less than the threshold value T3 (if the answer is YES in S24), the set state detector 34 compares the angular difference between the tool's 2 current orientation and the reference orientation with an angular difference threshold value T5 based on the movement information (in S25). In this embodiment, the angular difference threshold value T5 may be, for example, 10 degrees. If the angular difference between the tool's 2 current orientation and the reference orientation less than the threshold value T5 (if the answer is YES in S25), the LED of the light-emitting unit 234 for shooting turns ON (in S26). Then, the state of the processor 35 turns into the state St1, i.e., the standby state (in S27). In that case, the process proceeds to the processing step S65 shown in FIG. 7. Note that if the acceleration of the tool 2 is equal to or less than the threshold value T1 (if the answer is NO in S23), if the acceleration of the tool 2 is equal to or greater than the threshold value T3 (if the answer is NO in S24), or if the angular difference between the tool's 2 current orientation and the reference orientation is equal to or greater than the threshold value T5 (if the answer is NO in S25), then the process proceeds to the processing step S65 shown in FIG. 7.

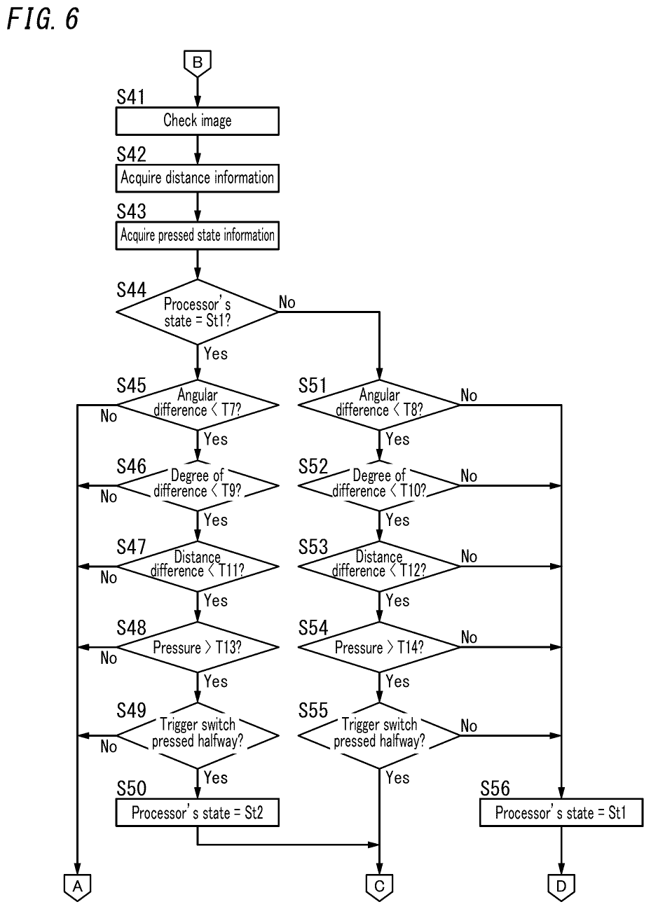

On the other hand, if it turns out in Step S22 that the state of the processor 35 is not the state St0 but is either the state St1 or the state St2 (i.e., if the answer is NO in S22), the set state detector 34 compares the acceleration of the tool 2 with an acceleration threshold value T2 based on the movement information (in S31). When finding the acceleration of the tool 2 greater than the threshold value T2 (if the answer is YES in S31), the set state detector 34 compares the acceleration of the tool 2 with another acceleration threshold value T4 based on the movement information (in S32). When finding the acceleration of the tool 2 less than the threshold value T4 (if the answer is YES in S32), the set state detector 34 compares the angular difference between the tool's 2 current orientation and the reference orientation with an angular difference threshold value T6 based on the movement information (in S33). If the angular difference between the tool's 2 current orientation and the reference orientation is less than the angular difference threshold value T6 (if the answer is YES in S33), the process proceeds to the processing step S41 shown in FIG. 6. Note that if the acceleration of the tool 2 is equal to or less than the threshold value T2 (if the answer is NO in S31), if the acceleration of the tool 2 is equal to or greater than the threshold value T4 (if the answer is NO in S32), or if the angular difference between the tool's 2 current orientation and the reference orientation is equal to or greater than the threshold value T6 (if the answer is NO in S33), then the process proceeds to the processing step S34.

In this case, if the state of the processor 35 is either the state St1 or the state St2, then the LED of the light-emitting unit 234 for shooting is in ON state. When the LED in ON state turns OFF (in S34), the state of the processor 35 turns into the state St0, i.e., the idle state (in S35). Then, the state of the motor included in the driving unit 24 turns into the state St3 (in S36). As used herein, the “state St3” refers to a state where the motor of the driving unit 24 is prohibited from running even if the trigger switch 221 is pulled by the user. After the state of the motor has turned into the state St3, the process proceeds to the processing step S65 shown in FIG. 7.

Note that the acceleration threshold values T1, T2 according to this embodiment are each set to have hysteresis and the threshold value T2 is smaller than the threshold value T1. In the same way, the acceleration threshold values T3, T4 are also each set to have hysteresis and the threshold value T4 is larger than the threshold value T3. Likewise, the angular difference threshold values T5, T6 are also each set to have hysteresis and the threshold value T6 is larger than the threshold value T5.

Next, the processing steps S41-S56 will be described with reference to FIG. 6. The stability determiner 33 checks the latest frame (first frame) of the captured image (in S41). Meanwhile, the set state detector 34 acquires the distance information from the distance measuring unit 27 (in S42) and acquires the pressed state information from the pressed state detection unit 28 (in S43). Next, the set state detector 34 sees if the state of the processor 35 is state St1 (in S44). If the state of the processor 35 is the state St1 (if the answer is YES in S44), the set state detector 34 compares the angular difference between the tool's 2 current orientation and the reference orientation with an angular difference threshold value T7 based on the movement information (in S45). The angular difference threshold value T7 according to this embodiment may be 5 degrees, for example. When finding the angular difference between the tool's 2 current orientation and the reference orientation less than the threshold value T7 (if the answer is YES in S45), the stability determiner 33 calculates the degree of difference between the latest frame of the captured image and the previous frame (second frame) preceding the latest frame. Then, the stability determiner 33 compares the degree of difference calculated by itself with a degree of difference threshold value T9 (in S46). When finding the degree of difference calculated by itself less than the threshold value T9 (if the answer is YES in S46), the stability determiner 33 outputs stability information to the set state detector 34 and the processor 35. Next, the set state detector 34 calculates a distance difference based on the distance information and compares the distance difference with a threshold distance T11 (in S47). When finding the distance difference less than the threshold distance T11 (if the answer is YES in S47), the set state detector 34 compares the pressure applied to the rear surface of the grip 22 with a threshold pressure T13 based on the pressed state information (in S48). When finding the pressure applied to the rear surface of the grip 22 greater than the threshold pressure T13 (if the answer is YES in S48), the set state detector 34 sees if the trigger switch 221 has been pressed halfway (in S49). When finding the trigger switch 221 pressed halfway (if the answer is YES in S49), the set state detector 34 outputs set state detection information to the processor 35. Then, the state of the processor 35 turns into the state St2 (i.e., the state where the processor 35 is performing the identification processing) (in S50) and the process proceeds to the processing step S61 shown in FIG. 7.

Note that if the angular difference is equal to or greater than the threshold value T7 (if the answer is NO in S45), if the degree of difference is equal to or greater than the threshold value T9 (if the answer is NO in S46), if the distance difference is equal to or greater than the threshold distance T11 (if the answer is NO in S47), if the pressure applied is equal to or less than the threshold pressure T13 (if the answer is NO in S48), or if the trigger switch 221 has not been pressed halfway (if the answer is NO in S49), then the process proceeds to the processing step S65 shown in FIG. 7.

When finding, in S44, the state of the processor 35 not the state St1 but the state St2 (if the answer is NO in S44), the set state detector 34 compares the angular difference between the tool's 2 current orientation and the reference orientation with an angular difference threshold value T8 based on the movement information (in S51). When finding the angular difference between the tool's 2 current orientation and the reference orientation less than the threshold value T8 (if the answer is YES in S51), the stability determiner 33 calculates the degree of difference between the first frame and the second frame. Then, the stability determiner 33 compares the degree of difference calculated by itself with a degree of difference threshold value T10 (in S52). When finding the degree of difference calculated by itself less than the threshold value T10 (if the answer is YES in S52), the stability determiner 33 outputs stability information to the set state detector 34 and the processor 35. Next, the set state detector 34 calculates a distance difference based on the distance information and compares the distance difference with a threshold distance T12 (in S53). When finding the distance difference less than the threshold distance T12 (if the answer is YES in S53), the set state detector 34 compares the pressure applied to the rear surface of the grip 22 with a threshold pressure T14 based on the pressed state information (in S54). When finding the pressure applied to the rear surface of the grip 22 greater than the threshold pressure T14 (if the answer is YES in S54), the set state detector 34 sees if the trigger switch 221 has been pressed halfway (in S55). When finding the trigger switch 221 pressed halfway (if the answer is YES in S55), the set state detector 34 outputs set state detection information to the processor 35. Then, the process proceeds to the processing step S61 shown in FIG. 7.

Note that if the angular difference is equal to or greater than the threshold value T8 (if the answer is NO in S51), if the degree of difference is equal to or greater than the threshold value T10 (if the answer is NO in S52), if the distance difference is equal to or greater than the threshold distance T12 (if the answer is NO in S53), if the pressure applied is equal to or less than the threshold pressure T14, or if the trigger switch 221 has not been pressed halfway (if the answer is NO in S55), then the state of the processor 35 turns from the state St2 into the state St1 (in S56) and the process proceeds to the processing step S64 shown in FIG. 7.

Note that the angular difference threshold values T7, T8 according to this embodiment are each set to have hysteresis and the threshold value T8 is larger than the threshold value T7. In the same way, the degree of difference threshold values T9, T10 are also each set to have hysteresis and the threshold value T10 is larger than the threshold value T9. Likewise, the threshold distances T11, T12 are also each set to have hysteresis and the threshold distance T12 is larger than the threshold distance T11. Likewise, the threshold pressures T13, T14 are also each set to have hysteresis and the threshold pressure T14 is smaller than the threshold pressure T13.

Next, the processing steps S61-S74 will be described with reference to FIG. 7. Upon receiving at least one of the stability information provided by the stability determiner 33 or the set state detection information provided by the set state detector 34, the processor 35 performs the identification processing based on the captured image (in S61). Then, the processor 35 sees if the current work target has been identified successfully and whether the work target thus identified follows the procedure of operations (in S62). If the processor 35 has identified the current work target successfully and the work target thus identified follows the procedure of operations (if the answer is YES in S62), then the state of the motor turns into a state St4 (in S63). As used herein, the “state St4” refers to a state where the motor included in the driving unit 24 starts running in response to the trigger switch 221 being pulled by the user to turn ON. After the state of the motor has turned into the state St4, the process proceeds to the processing step S65.

On the other hand, if the processor 35 has failed to identify the current work target in S62 or unless the work target identified follows the procedure of operations (if the answer is NO in S62), the state of the motor turns into a state St3 (in S64). After the state of the motor has turned into the state St3, the process proceeds to the processing step S65.

In the processing step S65, the processor 35 determines, in accordance with the movement information provided by the tool movement detection unit 26, whether the state where the tool 2 causes no movement has lasted for a prescribed amount of time (in S65). Unless the state where the tool 2 causes no movement has lasted for a prescribed amount of time, the processor 35 maintains either the current state St1 or the state St2. On the other hand, if the state where the tool 2 causes no movement has lasted for a prescribed amount of time, then the processor 35 turns its own state into the state St0 (in S66) where the identification processing is not started. As can be seen, if a state where the degree of movement of the tool 2 as detected by the tool movement detection unit 26 is equal to or less than a predetermined value has lasted for the prescribed amount of time, then the processor 35 suspends the identification processing. If such a state where the degree of movement of the tool 2 is equal to or less than a predetermined value has lasted for the prescribed amount of time, then the processor 35 may determine that no operations be performed on the work target. This allows the processor 35 to cut down the power consumption of the tool system 1 by suspending the identification processing.

Next, when the trigger switch 221 is pulled by the user to turn ON (if the answer is YES in S67), the start of operations detector 300 detects, in accordance with the operating signal supplied from the trigger switch 221, that operations have been started on the work target (in S68) and outputs a start of operations detection signal to the processor 35. On receiving the start of operations detection signal, the processor 35 turns the state of the processor 35 into the state St0, i.e., a locked state where the identification processing is suspended (in S69). In this case, on receiving the start of operations detection signal, the processor 35 may turn its own state into the state St0 to keep the locked state where the identification processing is suspended for a certain amount of time (i.e., for a predetermined pause period).

Alternatively, the start of operations detector 300 may detect, if the pressed state detection unit 28 detects the pressed state in a state where the work target has been identified, that operations have been started on the work target. Still alternatively, the start of operations detector 300 may detect, if the driving detector 39 detects that the (motor of the) driving unit 24 is activated (i.e., running), in the state where the work target has been identified, that operations have been started on the work target.

Optionally, the start of operations detector 300 may detect, based on at least one selected from the group consisting of the operating signal of the trigger switch 221, the detection signal of the pressed state detection unit 28, and the detection signal of the driving detector 39, that operations have been started on the work target.

In this case, the processor 35 has suspended the image processing on the captured image in the identification processing, and therefore, may cut down the power consumption of the tool 2 by disabling some of the functions of the processor 35. Optionally, once the start of operations detector 300 detects the start of the operations, the processor 35 may also suspend the image capturing operation by the image capturing unit 5, thus enabling further cutting down the power consumption of the tool 2.

If the trigger switch 221 has turned ON, the processor 35 sees if the state of the motor is the state St4 (in S70). If the state of the motor is the state St4 (if the answer is YES in S70), the processor 35 allows a fastening operation to be performed by running the motor included in the driving unit 24. As a result, the fastening operation is performed by running the motor (in S71). In this processing step, the driving controller 31 of the tool 2 controls the driving unit 24 such that the target torque value associated with the work target identified becomes the preset torque value. When the fastening operation is done, the processing ends.

At this point, the processor 35 determines whether the operations on the work target have been finished or not (in S73). For example, if the processor 35 detects, based on the pressure detected by the pressed state detection unit 28, for example, that the state where the tool 2 is pressed against the work target has ended (if the answer is YES in S73), the processor 35 cancels the locked state where the identification processing is suspended (in S74) to end the operation. That is to say, if the pressed state detection unit 28 detects the end of the pressed state after the identification processing has been suspended, then the processor 35 cancels the locked state where the identification processing is suspended. Once the pressed state has ended, the operations on the work target have already been done, and therefore, the processor 35 is allowed to resume the identification processing of identifying a new work target. In addition, the locked state will last until the pressed state ends since the identification processing has been suspended. Thus, the power consumption of the tool system 1 may be cut down by suspending the identification processing while the operations are being performed on the work target.

Optionally, when a predetermined pause period passes since the timing when the processor 35 has detected, based on the pressure detected by the pressed state detection unit 28, the end of the state where the tool 2 is pressed against the work target, the processor 35 may cancel the locked state where the identification processing is suspended. That is to say, when the predetermined pause period passes since the identification processing has been suspended, the processor 35 may cancel the locked state where the identification processing is suspended. Thus, the power consumption of the tool system 1 may be cut down by suspending the identification processing during the pause period in which operations are highly likely to be being performed on the work target.

Also, when the driving detector 39 detects, in Step S73, that the (motor of the) driving unit 24 has been deactivated (i.e., has stopped running), the processor 35 may detect that the operations on the work target have been done. In that case, the processor 35 may cancel the locked state where the identification processing is suspended either at the timing when the driving unit 24 has been detected to be deactivated or when a certain amount of time (pause period) has passed since the timing when the driving unit 24 has been detected to be deactivated. That is to say, when the driving detector 39 detects that the driving unit 24 has been deactivated after the identification processing has been suspended, the processor 35 may cancel the locked state where the identification processing is suspended. Once the driving unit 24 has been deactivated, the operations on the work target have already been done, and therefore, the processor 35 is allowed to resume the identification processing of identifying a new work target. In addition, the locked state will last until the driving unit 24 is deactivated since the identification processing has been suspended. Thus, the power consumption of the tool system 1 may be cut down by suspending the identification processing while the operations are being performed on the work target.

Alternatively, when the processor 35 receives, in Step S73, an end-of-operations signal, indicating that the operations on the work target have been done, from the tool 2, the processor 35 may detect that the operations on the work target have been done. In that case, the processor 35 may cancel the locked state where the identification processing is suspended either at the timing when the end-of-operations signal is received or when a certain amount of time (pause period) has passed since the timing when the end-of-operations signal has been received. That is to say, on receiving the end-of-operations signal, indicating that the operations have been done, from the tool 2 after the identification processing has been suspended, the processor 35 may cancel the locked state where the identification processing is suspended. Once the end-of-operations signal has been received, the processor 35 cancels the locked state, and therefore, is allowed to resume the identification processing of identifying a new work target. In addition, the locked state will last until the end-of-operations signal is received since the identification processing has been suspended. Thus, the power consumption of the tool system 1 may be cut down by suspending the identification processing while the operations are being performed on the work target.

On the other hand, if it turns out in Step S70 that the state of the motor is not the state St4but the state St3 (if the answer is NO in S70), then the processor 35 performs an alert operation such as lighting the notification unit 211 in red (in S72) to end the operation. Note that the motor included in the driving unit 24 does not run in that case.

Note that the flowchart shown in FIGS. 5-7 shows only an exemplary procedure of processing and should not be construed as limiting. Optionally, the processing steps shown in FIGS. 5-7 may be performed in a different order as appropriate from the illustrated one, some of the processing steps shown in FIGS. 5-7 may be omitted as appropriate, and/or an additional processing step may be performed as needed.

### (4) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. The drawings referred to in the foregoing description of embodiments are all schematic representations. Thus, the ratio of the dimensions (including thicknesses) of respective constituent elements illustrated on the drawings does not always reflect their actual dimensional ratio.

When any of the various parameters for use in the present disclosure is compared with its corresponding threshold value, it is arbitrarily changeable, depending on selection of the threshold value or any preset value, whether or not the phrase “equal to or greater than” covers e situation where two values being compared with each other are equal to each other. Therefore, from a technical point of view, there is no difference between the phrase “equal to or greater than” and the phrase “greater than.” Likewise, when any of the various parameters for use in the present disclosure is compared with its corresponding threshold value, there is no difference, from a technical point of view, between the phrase “equal to or less than” and the phrase “less than.”

Furthermore, the functions to be performed by the tool system 1 according to the exemplary embodiment described above may also be implemented by a work target identification method, a (computer) program, or a non-transitory storage medium on which the program is stored. A work target identification method according to an aspect includes an identification processing step and a start of operations detection step. The identification processing step includes performing image processing on a captured image generated by making an image capturing unit 5 capture an image of a work target and thereby determining whether the work target matches any of one or more preregistered targets. The image capturing unit 5 is provided for a portable tool 2. The tool 2 includes a driving unit 24 to be activated with motive power supplied from a power source. The start of operations detection step includes detecting a start of operations on the work target in a state where the work target is identified to be any of the one or more targets as a result of the identification processing step. The identification processing step includes suspending the image processing on the captured image once the start of operations has been detected in the start of operations detection step. A program according to another aspect is designed to cause a computer system to perform the work target identification method described above.

Next, variations of the exemplary embodiment will be enumerated one after another. Note that the variations to be described below may be adopted in combination as appropriate.

The tool system 1 may measure, based on the image captured by the image capturing unit 5 implemented as a stereoscopic camera, the distance between the image capturing unit 5 and the work target. Then, the set state detector 34 may detect, when finding the absolute value of the difference calculated by subtracting the distance between the image capturing unit 5 and the work target from the reference distance equal to or less than the threshold value, the state where the tool 2 is set in place on the work target.

Optionally, while the processor 35 is performing the identification processing, at least one of the captured image or the reference image may be subjected, in accordance with the movement information, to spin compensation and/or distortion correction. As used herein, the “distortion correction” means making correction to the captured image by partially expanding or shrinking the captured image (or reference image) to an arbitrary degree. For example, the processor 35 may obtain a captured image in which a rectangular subject is shot in a rectangular shape by subjecting a captured image in which the rectangular subject is shot in a trapezoidal shape to the distortion correction.

The “predetermined orientation” may be an orientation of the tool 2 in a situation where the angular difference between the rotational angle of the tool 2 around any one of the three axes, determining its current orientation detected by the tool movement detection unit 26, and the corresponding one of the rotational angles defining its reference orientation is equal to or less than a threshold value.

In the embodiment described above, the set state detector 34 determines, based on the respective detection results obtained by the tool movement detection unit 26, the distance measuring unit 27, and the pressed state detection unit 28, whether the work target has been set in place on the tool 2. Alternatively, the set state detector 34 may also determine, based on the detection results obtained by at least one selected from the group consisting of the tool movement detection unit 26, the distance measuring unit 27, and the pressed state detection unit 28, whether the work target has been set in place on the tool 2. That is to say, the tool 2 does not have to include all of, but needs to include at least one of, the tool movement detection unit 26, the distance measuring unit 27, and the pressed state detection unit 28. For example, the set state detector 34 may determine, based on the detection result obtained by the tool movement detection unit 26, whether the work target has been set in place on the tool 2. In that case, the distance measuring unit 27 and the pressed state detection unit 28 may be omitted as appropriate.

Furthermore, in the embodiment described above, the processor 35 is configured to prevent, even if the trigger switch 221 is pulled, the driving unit 24 from being activated unless the current work target identified by the identification processing matches the next work target defined by the procedure of operations. However, the processor 35 does not have to operate in this manner. For example, if operations do not have to be performed as per the order defined by the procedure of operations on a plurality of work targets in a single workpiece, then the processor 35 does not have to determine whether the current work target conforms with the order of operations process defined by the procedure of operations but may activate the driving unit 24 and have operations on the current work target done in accordance with an operating command entered via the trigger switch 221.

In the image registration processing in the registration mode, the tool's 2 orientation detected by the tool movement detection unit 26 (i.e., movement information) may also be stored in the (image storage device 41 of the) storage unit 4 in association with the reference image generated by the image capturing unit 5. This allows the reference image and the tool's 2 orientation to be registered in association with each other. Thus, once the captured image and the tool's 2 orientation have been determined in the working mode, the processor 35 may compare the captured image with a reference image associated with that orientation. Alternatively, the tool's 2 orientation associated with the reference image may be defined as the reference orientation.

Also, in the image registration processing in the registration mode, the distance detected by the distance measuring unit 27 between the tool 2 and the work target (distance information) may be defined to be a reference distance and stored in the (image storage device 41 of the) storage unit 4 in association with the reference image generated by the image capturing unit 5. Furthermore, in the image registration processing in the registration mode, the pressure detected by the pressed state detection unit 28 as being applied to the grip 22 (pressed state information) may also be stored in the (image storage device 41 of the) storage unit 4 in association with the reference image generated by the image capturing unit 5.

The stability determiner 33 may calculate the degree of matching (resemblance) between the first and second frames to determine whether the captured image is stabilized or not. The stability determiner 33 may calculate the degree of matching between the first and second frames by normalized cross-correlation (NCC) method, for example.

Optionally, the stability determiner 33 may also calculate, while performing the stability determination processing, the degree of difference by comparing the luminance value of a particular area in the first frame with a luminance value as a moving average of the corresponding particular areas in the second frame and one or more previous (past) frames preceding the second frame. In that case, the processing load on the stability determiner 33 increases in terms of the stability determination processing but the accuracy of the stability determination processing improves, which is an advantage.

Optionally, the stability determiner 33 may perform the stability determination processing by performing, on the first frame, pattern recognition processing using other frames, including the second frame, as template data.

The tool system 1 according to the present disclosure or the agent that performs the work target identification method according to the present disclosure includes a computer system. The computer system includes a processor and a memory as principal hardware components thereof. The computer system performs the functions of the tool system 1 according to the present disclosure or serves as the agent that performs the work target identification method according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the tool system 1 are integrated together in a single housing. However, this is not an essential configuration for the tool system 1. Alternatively, those constituent elements of the tool system 1 may be distributed in multiple different housings. Still alternatively, at least some functions of the tool system 1 may be implemented as a cloud computing system as well.

Furthermore, the image capturing unit 5 does not have to be provided for the barrel 21 of the body 20 but may be provided for either the attachment 23 of the body 20 or the battery pack 201, for example. Likewise, the arrangement of the control unit 3a, 3b, the storage unit 4, and other units may also be changed as appropriate. Also, the tool 2 may include the image capturing unit 5.

Optionally, the work target identification system 10 may be attached as an external device to the tool 2. In that case, the control unit 3a of the tool 2 and the control unit 3b of the work target identification system 10 may either be electrically connected to each other directly or communicate with each other via communications units. In the latter case, the communications units may adopt a wireless communications protocol compliant with a standard such as Wi-Fi (R), Bluetooth (R), ZigBee (R), or a low power radio standard requiring no licenses (e.g., the Specified Low Power Radio Station standard). Also, the work target identification system 10 may include a power source different from the battery pack 201 and the power source different from the battery pack 201 may be used as a power source for the image capturing unit 5 and the control unit 3b, for example.

When determining that the captured image be stabilized, the stability determiner 33 may output the stability information to only the set state detector 34.

Even if the processor 35 has not received the stability information provided by the stability determiner 33, the processor 35 may perform the predetermined processing including the identification processing, as long as the processor 35 has received at least the set state detection information provided by the set state detector 34.

Note that the tool system 1 does not have to be applied to the assembly line, on which workpieces are assembled at a factory, but may find any other application as well.

In the embodiment described above, the tool 2 is an impact wrench. However, the tool 2 does not have to be an impact wrench but may also be a nut runner or an oil pulse wrench, for example. Alternatively, the tool 2 may also be a screwdriver (including an impact screwdriver) for use to fasten screws (as fastening members), for example. In that case, a bit (such as a screwdriver bit) is attached to the tool 2 instead of the socket 242. Furthermore, the tool 2 does not have to be configured to be powered by the battery pack 201 but may also be configured to be powered by an AC power supply (commercial power supply). Moreover, the tool 2 does not have to be an electric tool but may also be an air tool including an air motor (driving unit) to be activated by compressed air (power) supplied from an air compressor (power source).

Also, in the exemplary embodiment described above, the work target is supposed to be each of a plurality of portions to be fastened in a single workpiece. However, this is only an example and should not be construed as limiting. Alternatively, the work target may also be a module, component, or product with a plurality of portions to be fastened. If the work target is a module, component, or product with a plurality of portions to be fastened, for example, the plurality of portions to be fastened of a single work target may have either the same target torque value or mutually different target torque values, whichever is appropriate.

Furthermore, the notification unit 211 does not have to be a light-emitting unit such as an LED but may also be implemented as an image display device such as a liquid crystal display or an organic electroluminescent (EL) display. Optionally, the notification unit 211 may make notification (presentation) by any means other than displaying. For example, the notification unit 211 may also be implemented as a loudspeaker or a buzzer that emits a sound (including a voice). In that case, the notification controller 36 preferably makes the notification unit 211 emit different sounds in a situation where the decision result made by the processor 35 indicates disagreement and in a situation where the processor 35 has identified the current work target. Still alternatively, the notification unit 211 may also be implemented as, for example, a vibrator that produces vibration or a transmitter for transmitting a notification signal to an external terminal (such as a mobile communications device) provided outside of the tool 2. Optionally, the notification unit 211 may also have, in combination, two or more functions selected from displaying, emitting a sound, producing vibration, and establishing communication, for example.

The storage unit 4 may store procedure of operations data indicating a predetermined order in which operations process steps are to be performed on a plurality of work targets. In that case, the processor 35 selects, in accordance with the procedure of operations, a reference image for use in identification processing out of the plurality of reference images. Specifically, the processor 35 preferentially selects one reference image, corresponding to a forthcoming work target to be processed in a forthcoming operations process step, out of the plurality of reference images. As used herein, the “forthcoming work target” is a work target to be processed next to the work target that has been identified last time. The processor 35 performs image processing of comparing the reference image selected as template data with the captured image. That is to say, the processor 35 selects the reference image by predicting the current work target to be shot in the captured image next time in accordance with the procedure of operations. This allows the processor 35 to identify, in a shorter time, the current work target shot in the captured image.

### Recapitulation

The exemplary embodiment and its variations described above are specific implementations of the following aspects of the present disclosure.

A tool system (1) according to a first aspect includes a portable tool (2), an image capturing unit (5), a processor (35), and a start of operations detector (300). The tool (2) includes a driving unit (24) to be activated with motive power supplied from a power source. The image capturing unit (5) is provided for the tool (2) and generates a captured image of a work target for the tool (2). The processor (35) performs identification processing including performing image processing on the captured image generated by the image capturing unit (5) and thereby determining whether the work target matches any of one or more preregistered targets. The start of operations detector (300) detects a start of operations on the work target in a state where the work target is identified to be any of the one or more targets as a result of the identification processing. The processor (35) suspends, once the start of operations detector (300) has detected the start of operations, the image processing on the captured image in the identification processing.

According to this aspect, once the tool (2) has started performing operations on the work target, there is no need to perform the identification processing of identifying the work target. Thus, the power consumption of the tool system (1) may be cut down by suspending the image processing on the captured image in the identification processing.

In a tool system (1) according to a second aspect, which may be implemented in conjunction with the first aspect, once the start of operations detector (300) has detected the start of the operations, the processor (35) further suspends an image capturing operation by the image capturing unit (5).

This aspect allows the power consumption of the tool system (1) to be further cut down by making the image capturing unit (5) suspend the image capturing operation in a state where the tool (2) has started performing operations on the work target.

A tool system (1) according to a third aspect, which may be implemented in conjunction with the first or second aspect, further includes a notification unit (211) that makes notification of a result of the identification processing.

This aspect allows the user of the tool (2) to learn about the result of the identification processing.

In a tool system (1) according to a fourth aspect, which may be implemented in conjunction with any one of the first to third aspects, the start of operations detector (300) detects the start of the operations in response to an input signal supplied from an operating button to be operated when the operations start to be performed.

This aspect allows the start of operations detector (300) to detect the start of the operations by sensing the user operate the operating button at the start of the operations.

In a tool system (1) according to a fifth aspect, which may be implemented in conjunction with the fourth aspect, the operating button includes a trigger switch (221) to activate the driving unit (24) to a degree of activation corresponding to a pull depth.

This aspect allows the start of operations detector (300) to detect the start of the operations by sensing the user pull the trigger switch (221) at the start of the operations.

A tool system (1) according to a sixth aspect, which may be implemented in conjunction with any one of the first to fifth aspects, further includes a pressed state detection unit (28) that detects a pressed state where the tool (2) is pressed against the work target. The start of operations detector (300) detects the start of the operations when the pressed state detection unit (28) detects the pressed state after the work target has been identified through the identification processing.

This aspect allows the start of operations detector (300) to detect the start of the operations based on a result of detection obtained by the pressed state detection unit (28) that has detected the pressed state where the tool (2) is pressed against the work target.

A tool system (1) according to a seventh aspect, which may be implemented in conjunction with any one of the first to sixth aspects, further includes a driving detector (39). The driving detector (39) detects an activated state of the driving unit (24). The start of operations detector (300) detects the start of the operations based on a result of detection obtained by the driving detector (39).

This aspect allows the start of operations detector (300) to detect the start of operations based on the activated state of the driving unit (24).

A tool system (1) according to an eighth aspect, which may be implemented in conjunction with any one of the first to seventh aspects, further includes a tool movement detection unit (26) that detects any movement of the tool (2). The processor (35) suspends the identification processing when the movement of the tool (2) as detected by the tool movement detection unit (26) remains equal to or less than a predetermined value for a prescribed amount of time.

This aspect enables determining, when the movement of the tool (2) remains equal to or less than a predetermined value for a prescribed amount of time, that no operations are being performed on the work target. Thus, the power consumption of the tool system (1) may be cut down by suspending the identification processing.

In a tool system (1) according to a ninth aspect, which may be implemented in conjunction with any one of the first to eighth aspects, when a predetermined pause period has passed since the identification processing started to be suspended, the processor (35) cancels a locked state where the identification processing is suspended.

This aspect allows the power consumption of the tool system (1) to be cut down by suspending the identification processing for a period in which operations are highly likely to be being performed on the work target.

A tool system (1) according to a tenth aspect, which may be implemented in conjunction with any one of the first to ninth aspects, further includes a pressed state detection unit (28) that detects a pressed state where the tool (2) is pressed against the work target. When the pressed state detection unit (28) detects an end of the pressed state after the identification processing has been suspended, the processor (35) cancels a locked state where the identification processing is suspended.

This aspect allows the power consumption of the tool system (1) to be cut down by suspending the identification processing while operations are being performed on the work target.

A tool system (1) according to an eleventh aspect, which may be implemented in conjunction with any one of the first to tenth aspects, further includes a driving detector (39) that detects an activated state of the driving unit (24). When the driving detector (39) detects deactivation of the driving unit (24) after the identification processing has been suspended, the processor (35) cancels a locked state where the identification processing is suspended.

This aspect allows the power consumption of the tool system (1) to be cut down by suspending the identification processing while operations are being performed on the work target.

In a tool system (1) according to a twelfth aspect, which may be implemented in conjunction with any one of the first to eleventh aspects, on receiving, from the tool (2), an end-of-operations signal making notification that the operations have ended after the identification processing has been suspended, the processor (35) cancels a locked state where the identification processing is suspended.

This aspect allows the power consumption of the tool system (1) to be cut down by suspending the identification processing while operations are being performed on the work target.

A work target identification method according to a thirteenth aspect includes an identification processing step and a start of operations detection step. The identification processing step includes performing image processing on a captured image generated by making an image capturing unit (5) capture an image of a work target and thereby determining whether the work target matches any of one or more preregistered targets. The image capturing unit (5) is provided for a portable tool (2). The tool (2) includes a driving unit (24) to be activated with motive power supplied from a power source. The start of operations detection step includes detecting a start of operations on the work target in a state where the work target is identified to be any of the one or more targets as a result of the identification processing step. The work target identification method includes suspending the image processing on the captured image in the identification processing step once the start of operations has been detected in the start of operations detection step.

According to this aspect, once the tool (2) has started performing operations on the work target, there is no need to perform identification processing of identifying the work target. Thus, the power consumption of the tool system (1) may be cut down by suspending the image processing on the captured image in the identification processing.

A program according to a fourteenth aspect is designed to cause a computer system to perform the work target identification method according to the thirteenth aspect.

According to this aspect, once the tool (2) has started performing operations on the work target, there is no need to perform identification processing of identifying the work target. Thus, the power consumption of the tool system (1) may be cut down by suspending the image processing on the captured image in the identification processing.

Note that these are not the only aspects of the present disclosure but various configurations (including variations) of the tool system (1) according to the exemplary embodiment described above may also be implemented as, for example, a work target identification method, a (computer) program, or a non-transitory storage medium on which the program is stored.

Note that the constituent elements according to the second to twelfth aspects are not essential constituent elements for the tool system (1) but may be omitted as appropriate.

### REFERENCE SIGNS LIST

1 Tool System
2 Tool
5 Image Capturing Unit
24 Driving Unit
28 Pressed State Detection Unit
35 Processor
39 Driving Detector
211 Notification Unit
221 Trigger Switch
300 Start of Operations Detector

1. A tool system comprising:
a tool including a driving unit, the driving unit being configured to be activated with motive power supplied from a power source, the tool being a portable tool;
an image capturing unit provided for the tool and configured to generate a captured image of a work target for the tool; and
a processor configured to perform identification processing including performing image processing on the captured image generated by the image capturing unit and thereby determining whether the work target matches any of one or more preregistered targets; and
a start of operations detector configured to detect a start of operations on the work target in a state where the work target is identified to be any of the one or more targets as a result of the identification processing,
the processor being configured to, once the start of operations detector has detected the start of operations, suspend the image processing on the captured image in the identification processing.

2. The tool system of claim 1, wherein
the processor is configured to, once the start of operations detector has detected the start of the operations, further suspend an image capturing operation by the image capturing unit.

3. The tool system of claim 1, further comprising a notification unit configured to make notification of a result of the identification processing.

4. The tool system of claim 1, wherein
the start of operations detector is configured to detect the start of the operations in response to an input signal supplied from an operating button, the operating button being to be operated when the operations start to be performed.

5. The tool system of claim 4, wherein
the operating button includes a trigger switch configured to activate the driving unit to a degree of activation corresponding to a pull depth.

6. The tool system of claim 1, further comprising a pressed state detection unit configured to detect a pressed state where the tool is pressed against the work target, wherein
the start of operations detector is configured to detect the start of the operations when the pressed state detection unit detects the pressed state after the work target has been identified through the identification processing.

7. The tool system of claim 1, further comprising a driving detector configured to detect an activated state of the driving unit, wherein
the start of operations detector is configured to detect the start of the operations based on a result of detection obtained by the driving detector.

8. The tool system of claim 1, further comprising a tool movement detection unit configured to detect any movement of the tool, wherein
the processor is configured to suspend the identification processing when the movement of the tool detected by the tool movement detection unit remains equal to or less than a predetermined value for a prescribed amount of time.

9. The tool system of claim 1, wherein
the processor is configured to, when a predetermined pause period has passed since the identification processing started to be suspended, cancel a locked state where the identification processing is suspended.

10. The tool system of claim 1, further comprising a pressed state detection unit configured to detect a pressed state where the tool is pressed against the work target, wherein
the processor is configured to, when the pressed state detection unit detects an end of the pressed state after the identification processing has been suspended, cancel a locked state where the identification processing is suspended.

11. The tool system of claim 1, further comprising a driving detector configured to detect an activated state of the driving unit, wherein
the processor is configured to, when the driving detector detects deactivation of the driving unit after the identification processing has been suspended, cancel a locked state where the identification processing is suspended.

12. The tool system of claim 1, wherein
the processor is configured to, on receiving, from the tool, an end-of-operations signal making notification that the operations have ended after the identification processing has been suspended, cancel a locked state where the identification processing is suspended.

13. A work target identification method comprising:
an identification processing step including performing image processing on a captured image generated by making an image capturing unit capture an image of a work target and thereby determining whether the work target matches any of one or more preregistered targets, the image capturing unit being provided for a portable tool including a driving unit, the driving unit being configured to be activated with motive power supplied from a power source; and
a start of operations detection step including detecting a start of operations on the work target in a state where the work target is identified to be any of the one or more targets as a result of the identification processing step,
the work target identification method including suspending the image processing on the captured image in the identification processing step once the start of operations has been detected in the start of operations detection step.

14. A computer-readable, non-transitory, and tangible recording medium recording a program to be stored in a computer, the program causing a computer system to perform the work target identification method of claim 13.

15. The tool system of claim 2, further comprising a notification unit configured to make notification of a result of the identification processing.

16. The tool system of claim 2, wherein
the start of operations detector is configured to detect the start of the operations in response to an input signal supplied from an operating button, the operating button being to be operated when the operations start to be performed.

17. The tool system of claim 3, wherein
the start of operations detector is configured to detect the start of the operations in response to an input signal supplied from an operating button, the operating button being to be operated when the operations start to be performed.

18. The tool system of claim 2, further comprising a pressed state detection unit configured to detect a pressed state where the tool is pressed against the work target, wherein
the start of operations detector is configured to detect the start of the operations when the pressed state detection unit detects the pressed state after the work target has been identified through the identification processing.

19. The tool system of claim 3, further comprising a pressed state detection unit configured to detect a pressed state where the tool is pressed against the work target, wherein
the start of operations detector is configured to detect the start of the operations when the pressed state detection unit detects the pressed state after the work target has been identified through the identification processing.

20. The tool system of claim 4, further comprising a pressed state detection unit configured to detect a pressed state where the tool is pressed against the work target, wherein
the start of operations detector is configured to detect the start of the operations when the pressed state detection unit detects the pressed state after the work target has been identified through the identification processing.
